(19) United States
(12) Patent Application Publication
(10) Pub. No.: US 2014/0229874 A1
(43) Pub. Date: Aug. 14, 2014

(54) BUILDING INFORMATION MANAGEMENT SYSTEM WITH BUILDING METADATA

(71) Applicant: Jason Matthew Strauss, Albuquerque, NM (US)

(72) Inventor: Jason Matthew Strauss, Albuquerque, NM (US)

(21) Appl. No.: 13/914,578

(22) Filed: Jun. 10, 2013

Related U.S. Application Data
(60) Provisional application No. 61/763,378, filed on Feb. 11, 2013.

(51) Int. Cl. G06F 3/0482

(52) U.S. Cl. CPC G06F 3/0482
USPC 715/771

(57) ABSTRACT

A Building Information Management System, comprising: a Building Information System comprising: a database of operational information comprising lessons learned and idiosyncrasies regarding the particular building and the particular equipment in any particular building, of precautionary statements, of device operational configuration information, history and presets, and of emergency procedures; an Input region; a search function for locating all devices of a specific type throughout the building or buildings; a Report writing function.

### CROSS-REFERENCE TO RELATED APPLICATIONS

Non-provisional of 61/763,378, file date 11 Feb. 2013.

### STATEMENTS REGARDING FEDERALLY SPONSORED RESEARCH AND DEVELOPMENT

Not applicable.

### BACKGROUND

The embodiments of the present invention satisfy the needs of having a better building information management system.

Information relevant to attempts to address these problems can be found in U.S. Pat. Nos. 7,249,322; 7,836,406; 8,024,054; 8,055,672; and 8,448,070; which are not admitted to be prior art with respect to the present invention by its mention in this Background Section. However, it is desirable to have a better method than is disclosed in the references.

There exist numerous types of building management software systems, each designed for different purposes. Building Information Systems (BIS) display floor plans and critical information for managers and first responders. U.S. Pat. No. 7,598,966 for example claims a method and system for displaying floor plans and site plans onto a computer screen, embellished with overlaying images depicting locations of elevators, evacuation stairways, fire hydrants, etc. The system however does not offer a searchable database of operating components in the building. Building Management Systems (BMS) and Building Automation Systems (BAS) allow a manager both to monitor and to control operating components in a building. Some have the floor plans as in a BIS, but these floor plans are not integrated with data on the positions of devices. U.S. Pat. No. 7,567,844, a BMS, claims an invention that allows a manager to monitor and control devices within a building, where devices comprise sensors, actuators, air handlers, chillers, steam plants, security systems, smoke detectors and lighting systems. U.S. Pat. No. 8,099,178, a BAS, claims an invention that displays static information and dynamic data about end devices. Static information in this patent consists of an end device location, type, version, communication protocol, communication protocol version, and manufacturer. Dynamic information includes device setpoint and variance, operating state, alarm, and occupancy status. Neither static nor dynamic information includes device metadata or building metadata, nor a database of device configurations. Computerized Maintenance Management Systems (CMMS) digitize the work order request and work order assignment processes. A CMMS does not allow one to monitor and control components that are operating within a building. U.S. Pat. No. 8,040,818, a CMMS, discloses a computer upkeep system, where upkeep refers to maintenance, inspection, service and improvement, and upkeep-relevant information includes measures of maintenance, inspection, service and improvement. CenterStone by Manhattan Software, is a typical CMMS. It allows a manager engage in space management, asset management (to store and access “asset histories—maintenance records, work orders, suppliers, labor, material costs, etc.”), operations management (managing preventive maintenance, service requests, work orders), lease management, workflow automation, and enterprise reporting.

The embodiments of the present invention comprise Building Information Management System, comprising: a Building Information System displaying floor plans and critical information, integrated with a database comprising a level of detail that previously existed only in Building Automation Systems; a database of operational information comprising “lessons learned” and idiosyncrasies regarding the particular building and the particular equipment in any particular building, or “device metadata” and “building metadata”; a database of device operational configuration information, history and presets; and a “super search” for locating all devices of a specific type throughout the entire campus. Thus, the Building Information Management System (BIMS) integrates previously unintegrated information. The embodiments of the present invention systematically records and manage institutional knowledge as a methodology for situational preparedness and operational efficiency. Institutional memory and situational preparedness form a symbiotic circle, and without this union neither is capable of maximizing potential for efficiency in dealing with a facility portfolio. BIMS is a facilities planning and response tool that creates a vehicle to capture institutional memory while dealing with situational preparedness to maximize potential.

The Building Information Management System (BIMS) will be useful to building managers who need overviews and summaries of building operations, whether in routine matters or in emergencies. It will preserve knowledge about operating a building, which knowledge would otherwise be lost or hard to find when the responsible personnel depart; thus the BIMS enables continuity of operational knowledge. It will further facilitate the work of first responders. It will assist in making multi-building determinations regarding equipment replacement or upgrade decisions.

The embodiments of the present invention also comprise a means for inputting information into the BIMS.

In the scenarios that follow, some or all of the maintenance personnel may have the institutional knowledge to deal with them in a timely manner. Often this is not the case for a multitude of reasons such as:
1. The event happened during non-business hours.
2. The person who has the information is either on vacation or out sick or otherwise unavailable.
3. There are multiple sources of information required in order to deal with the scenario and there is no access to all of the sources
4. There may be a universal plan for dealing with situations, but no such plan has been adopted at a building specific model.
5. And the like.
   This tool delivers what you need to know, when you need to know it, wherever you are, assuming that you have taken the necessary steps to populate the data with accurate information. This tool simultaneously provides a vehicle to capture institutional memory facility emergency protocols and translate that into a simple usable format for its end users. Two scenarios follow which can demonstrate these capabilities into four different segments:
1. The Situation:
2. Institutional knowledge captured
3. Facility specific planning captured
4. How those pieces of information come together to create a solution which dramatically reduces potential risk.

Scenario #01:
1. The Situation:
   a. There is a main hot water line leak inside of a building on the top floor of a 5 story building (building C).
2. Institutional knowledge captured
   a. The main hot water line shut off valve is located inside of an adjacent building (building A).
   b. This main hot water line shut off valve located in building A also shuts down a separate adjacent building (building B).
   c. The hot water distribution from building A goes through building B and then finally through to building C. So by shutting down the valve in building A, you are shutting down the heating source for two separate buildings.
   d. The locations of all the mechanical rooms where the hot water line can be found in all three buildings.
   e. From the outside of the building how to get to said mechanical rooms.
   f. The location of the building inside of your facilities portfolio (campus).
   g. The location of the other utility feeds for this building, and the subsequent shut of panels of valves.
   h. How to identify the type of water leak you have:
      Hot water the buildings heating Source
      Chilled water the buildings cooling Source
      Domestic hot and cold water
      Fire suppression
   i. The key that grants access to the building(s).
   j. The key that grants access to the mechanical room(s).
   k. The effect of shutting down heating to all three buildings.
3. Facility specific planning captured
   a. The protocol for a water leak inside of any building inside of your facilities portfolio.
   b. The protocol specific for building A, B, C in terms of water leaks.
   c. The utility type shut down order.
   d. The evacuation plan.
   e. Access plan
   f. The person who is authorized to deal with these situations.
4. How those pieces of information come together to create a solution which dramatically reduces potential risk.
   a. In scenario #01 when the water leak is identified, this system allows for authorized personnel to shut down all utility types necessary without having to spend any time finding the location of the shut off valves, mechanical rooms, buildings, or access to the buildings. A plan is displayed in several different formats which can be available to them on site or via a communication device from someone else who is looking at the tool. This type of systematic approach allows for critical time to be saved that could save lives, dollars, & jobs.

Scenario #02:
1. The Situation:
   a. There has been an explosion on the roof of a building of a rooftop gas fired heating unit. The police and fire department have come and evacuated the building and given an all clear. The maintenance staff is now going onto the roof to inspect the damage from the explosion only to discover that the gas line is still active and flowing currently.
2. Institutional knowledge captured
   a. The locations of all the mechanical rooms where the utility shut offs can be found.
   b. From the outside of the building how to get to said mechanical rooms.
   c. The location of the building inside of your facilities portfolio (campus).
   d. The key that grants access to the building(s).
   e. The key that grants access to the mechanical room(s).
   f. Areas that the gas fired unit covered
   g. The location of all mechanical systems on the roof.
   h. The bio and chemical hazards which are stored in this facility (physical inventory).
3. Facility specific planning captured
   a. The protocols for an explosion in any building inside of your facilities portfolio before and after the emergency responders have arrived.
   b. The utility type shut down order.
   c. The evacuation plan.
   d. Access plans
   e. The appropriate identification of all personnel who should be notified
4. How those pieces of information come together to create a solution which dramatically reduces potential risk.
   a. In scenario #02 the maintenance personnel could have had all of the utilities shut off before ever inspecting the roof. Authorized personnel could have instructed the emergency responders as to the location of the shut off valves and protocols in place for this particular building. The type quantity and age of any bio or chemical hazards on site. All of this could have taken place with or without the full maintenance staff present.

### SUMMARY

The embodiments of the present invention are directed to a method and/or device that satisfies the needs set out in the Background section.

The embodiments of the present invention comprise an electronic programmable apparatus to generate an electronic graphical user interface for permitting a user to interface with an electronic database configured to store information about a building or buildings, the apparatus comprising: an electronic computer processor, a volatile electronic computer memory and a non-volatile electronic computer memory in communication with the electronic computer processor, and an electronic display device for displaying the electronic graphical user interface wherein the electronic display device is in electronic communication with the electronic computer processor and the volatile and non-volatile electronic computer memories;

the electronic graphical user interface comprising:
a means for enabling a user to select at least one building from a plurality of buildings;
a first menu displaying: a first menu hyperlinking means for hyperlinking to a Buildings region, and a first menu hyperlinking means for hyperlinking to an Input region;
the Buildings region comprising a second menu displaying a second menu hyperlinking means for hyperlinking to a Critical Knowledge subregion, wherein the Critical Knowledge subregion displays information pertaining to critical operational metadata for the at least one building, the second menu further displaying a second menu hyperlinking means for hyperlinking to: a Building Knowledge subregion displaying building metadata and device metadata for the at least one building, a Building System subregion, an Action Items subregion, an Energy Conservation Opportunity (ECO) subregion, an Equipment subregion, a Building Personnel subregion, a Maintenance Personnel subregion, a Floor Plans subregion, a Schedule subregion, an Emergency subregion, a Note subregion, an Asset subregion, and a Utilities subregion;
the Input region displaying a plurality of controls for enabling a user to input data into the electronic database, the plurality of controls comprising: a means for enabling a user to specify a second building, a means for enabling a user to specify a second space located within the second building, a means for enabling a user to specify at least one subregion pertaining to the second space, a means for enabling a user to specify at least one attribute type of the at least one subregion pertaining to the second space.

Optionally, the first menu hyperlinking means for hyperlinking to an Input region is selected from the group consisting of hypertext, a computer icon, and a web button.

Optionally, the means for enabling a user to specify a second building is selected from the group consisting of a text entry box, a radio button, a computer icon, and a pull-down menu.

Optionally, the means for enabling a user to specify a second space located within the second building is selected from the group consisting of a text entry box, a radio button, a computer icon, and a pull-down menu; wherein a specification of the second space is selected from the group consisting of a space name, a space type, metadata regarding the space, a precautionary statement, a National Fire Protection Association rating, a building floor, a compass direction, a room number, a key number, an indication for whether the space has a proxy access, an indication for whether the space has a key card access, an indication for whether the space is alarmed, an indication for whether the space is an emergency exit, an indication for whether the space is an elevator, an indication for whether the space is a stairwell an indication for whether the space is a building exit, an indication for whether the space is a main shut-off for a utility, and combinations thereof; wherein precautionary statements are selected from the group consisting of danger, warning, caution, note and none.

Optionally, the means for enabling a user to specify at least one subregion pertaining to the second space comprises a plurality of buttons wherein each button corresponds to a subregion.

Optionally, the means for enabling a user to specify at least one attribute type of the at least one subregion pertaining to the second space is selected from the group consisting of a hyperlinking means for hyperlinking to a Building System input subregion, a hyperlinking means for hyperlinking to a Utility input subregion, a hyperlinking means for hyperlinking to a Note input subregion, a hyperlinking means for hyperlinking to an Equipment input subregion, a hyperlinking means for hyperlinking to an Asset input subregion, and combinations thereof; wherein the hyperlinking means for hyperlinking to a Building System input subregion is selected from the group consisting of hypertext, a computer icon, and a web button; wherein the hyperlinking means for hyperlinking to a Utility input subregion is selected from the group consisting of hypertext, a computer icon, and a web button; wherein the hyperlinking means for hyperlinking to a Note input subregion is selected from the group consisting of hypertext, a computer icon, and a web button; wherein the hyperlinking means for hyperlinking to an Equipment input subregion is selected from the group consisting of hypertext, a computer icon, and a web button; wherein the hyperlinking means for hyperlinking to an Asset input subregion is selected from the group consisting of hypertext, a computer icon, and a web button.

Optionally, the Building System input subregion displays a means for inputting information pertaining to heating and cooling systems of the at least one building, wherein the information pertaining to heating and cooling systems is selected from the group consisting of an identifier for the information pertaining to the heating and cooling systems for the at least one building, an air handler unit type, an air handler unit configuration, an indication whether an air handler unit comprises a reheat design, an indication whether an air handler unit comprises a cooling design, an indication whether an air handler unit comprises a heating design, a control system type, an IP address for monitoring an air handler unit, a location of an air handler unit, an area served by an air handler unit, a note pertaining to an air handler unit, a hyperlink to documents relating to an handler unit, a precautionary statement, a National Fire Protection Association rating, and combinations thereof, wherein precautionary statements are selected from the group consisting of danger, warning, caution, note and none;
wherein the Utilities input subregion displays a means for inputting information pertaining to utilities for the at least one building, wherein the information pertaining to the utilities for the at least one building is selected from the group consisting of a utility type, a shut-off type, a list of associated buildings, a note, a precautionary statement, a National Fire Protection Association rating, and combinations thereof, wherein precautionary statements are selected from the group consisting of danger, warning, caution, note and none;
wherein the Note input subregion displays a means for inputting information pertaining to building operations and maintenance, wherein the information pertaining to building operations and maintenance is selected from the group consisting of a note type, a description, a priority, a responsible organization, a status, a status date, a completion date, a person assigned, a role, an assign date, a reminder, a precautionary statement, a National Fire Protection Association rating, and combinations thereof, wherein precautionary statements are selected from the group consisting of danger, warning, caution, note and none; wherein the note type is selected from the group consisting of Building Knowledge, Critical Knowledge, Action Items, ECO, Wish List, Space, Utilities, Asset and Building System;
wherein the Equipment input subregion displays a means for inputting information pertaining to equipment situated in the at least one building, wherein the information pertaining to equipment situated in the at least one building is selected from the group consisting of an equipment description, a major tag, a sub-location, a hyperlink to documents pertaining to equipment situated in the at least one building, a precautionary statement, a National Fire Protection Association rating, and combinations thereof, wherein precautionary statements are selected from the group consisting of danger, warning, caution, note and none;
   wherein the Asset input subregion displays a means for inputting information pertaining to assets situated in the first building, wherein information pertaining to assets situated in the first building is selected from the group consisting of a short description, a category, a note, a precautionary statement, a National Fire Protection Association rating, and combinations thereof, wherein precautionary statements are selected from the group consisting of danger, warning, caution, note and none.

Optionally, the non-volatile memory contains code configured to cause: any precautionary statement designated at a level above note to be displayed at least in the Emergency subregion; any National Fire Protection Agency rating designated at a rating greater than zero to be displayed at least in the Emergency subregion and in the Critical Knowledge subregion; any information designated as a utility category type to be displayed at least in the Emergency subregion and the Utilities subregion; any information designated with a start date and an end date to be displayed at least in the Action Item subregion; any information designated as an ECO to be displayed at least in the ECO subregion; any information designated as a Building System to be displayed at least in the Building System subregion; any information designated as equipment to be displayed at least in the Equipment subregion; any information designated as building personnel to be displayed at least in the Building Personnel subregion; any information designated as maintenance personnel to be displayed at least in the Maintenance Personnel subregion; any information designated as floor plans to be displayed at least in the Floor Plans subregion; any information designated as a schedule to be displayed at least in the Schedule subregion; all information not displayed in the Critical Knowledge subregion or the Emergency subregion to be displayed at least in the Building Knowledge subregion; any note type that is designated as Building Knowledge to be displayed in the Building Knowledge subregion; any note type designated as Critical Knowledge to be displayed in the Critical knowledge subregion; any note type designated as an Action Item to be displayed in the Action Items subregion; and any note type designated as a Wish List to be displayed in the Wish List subregion.

Optionally, the information pertaining to critical operational metadata for the at least one building is selected from the group consisting of an identifier for the critical operation metadata for the at least one building, a short description of a subject to which the critical operational metadata pertains, a note containing the critical operational metadata, a category to which the critical operational metadata pertains, a category detail, a checkbox to indicate an ECO, and a hyperlink to documents pertaining to the critical operational metadata for the at least one building, and combinations thereof.

Optionally, the second menu hyperlinking means for hyperlinking to a Critical Knowledge subregion is selected from the group consisting of hypertext, a computer icon, and a web button.

Optionally, the category to which the critical operational metadata pertains is selected from the group consisting of electrical, plumbing, fire, and controls.

Optionally, the building and device metadata for the at least one building is selected from the group consisting of a description of the building metadata and device metadata for the at least one building, an identifier for the building metadata and device metadata for the at least one building, a device category, a category detail, a checkbox to indicate an ECO, a hyperlink to documents pertaining to the building metadata and device metadata for the at least one building, and combinations thereof.

Optionally, the first menu hyperlinking means for hyperlinking to a Buildings region is selected from the group consisting of hypertext, a computer icon, and a web button.

Optionally, the second menu hyperlinking means for hyperlinking to a Building Knowledge subregion is selected from the group consisting of hypertext, a computer icon, and a web button.

Optionally, the means for enabling a user to select at least one building from a plurality of buildings is selected from the group consisting of a text entry box, a radio button, a computer icon, and a pull-down menu.

Optionally, the first menu further displays a first menu hyperlinking means for hyperlinking to a Super Search region, wherein the Super Search region displays a menu for selecting for display a first set of information for one or more buildings.

Optionally, the first set of information comprises locations indicated on a digital map.

Optionally, the menu for selecting for display a first set of information for one or more buildings comprises a Building Super Search region, wherein the Building Super Search region comprises a means for selecting information pertaining to physical building characteristics; wherein the information pertaining to physical building characteristics is selected from the group consisting of a building, a building number, an area, an address, a city, a zip code, a square feet, a year built, a campus, a map grid, a schedule, a type, a tag number, a floor, a set of drawings, a drawing type, and combinations thereof;
wherein the menu for selecting for display a first set of information for one or more buildings further comprises a Control/System Super Search region; wherein the Control/System Super Search region comprises a means for selecting Building Controls, System Numbers, and Modes of Distribution, wherein Building Controls comprise control type and schedule and location, wherein System Numbers comprise numerical identifiers of system types and area covered, and wherein Modes of Distribution comprise air handler, mechanical, POT feeder, system type, and VFD;
wherein the menu for selecting for display a first set of information for one or more buildings further comprises a People Super Search region, wherein the People Super Search region comprises a means for selecting a name, an identification number, Contact Information, Building Positions, and Area Positions, wherein Contact Information comprises a contact type and a priority, wherein Building Positions comprises an inactive date and an active date range, wherein Area Positions comprises a position and an area assigned;
wherein the menu for selecting for display a first set of information for one or more buildings further comprises a Note Super Search region comprising a means for selecting information pertaining to building operations and maintenance, wherein the information pertaining to building operations and maintenance is selected from the group consisting of a note type, a description, a priority, a responsible organization, a status, a status date, a completion date, a person assigned, a role, an assign date, a reminder, and combinations thereof; wherein the note type is selected from the group consisting of Building Knowledge, Critical Knowledge, Action Items, ECO, Wish List, Space, Utilities, Asset and Building System;
wherein the menu for selecting for display a first set of information for one or more buildings further comprises an Equipment Super Search region comprising a means for selecting information pertaining to building equipment, wherein information pertaining to building equipment is selected from the group consisting of an equipment description, a major tag, a sub-location, a hyperlink to documents pertaining to equipment situated in the at least one building, and combinations thereof;
wherein the menu for selecting for display a first set of information for one or more buildings further comprises an Asset Super Search region comprising a means for selecting information pertaining to building assets;
wherein the menu for selecting for display a first set of information for one or more buildings further comprises a Utilities Super Search region comprising a means for selecting information pertaining to utilities;
wherein the menu for selecting for display a first set of information for one or more buildings further comprises an Access Super Search region comprising a means for selecting information pertaining to building access;
wherein the menu for selecting for display a first set of information for one or more buildings further comprises a National Fire Protection Association rating region comprising a means for selecting information pertaining to National Fire Protection Association ratings;
   wherein the menu for selecting for display a first set of information for one or more buildings further comprises a precautionary statement region comprising a means for selecting information pertaining to precautionary statements.

Optionally, the embodiments of the invention further comprise a first menu means for designating a virtual building comprising a plurality of buildings.

Optionally, the first menu means for designating a virtual building is selected from the group consisting of hypertext, a computer icon, and a web button.

Optionally, the first menu further displays a first menu hyperlinking means for hyperlinking to a Report subregion, wherein the Report subregion displays a means for enabling a user to display a report of information stored in the electronic database on the at least one building.

Optionally, the first menu hyperlinking means for hyperlinking to a Report region is selected from the group consisting of hypertext, a computer icon, and a web button.

Optionally, the Report subregion further displaying a means for enabling a first user to display a report of information taken from a cached version of the electronic database that is stored in a non-volatile electronic memory in the first user's electronic computing device.

Optionally, the first menu further displays a first menu hyperlinking means for hyperlinking to an Administration subregion, wherein the Administration subregion displays information for the at least one building pertaining to personnel who are responsible for operating and managing the at least one building.

Optionally, the first menu hyperlinking means for hyperlinking to an Administration region is selected from the group consisting of hypertext, a computer icon, and a web button; wherein the second menu hyperlinking means for hyperlinking to a Building System subregion is selected from the group consisting of hypertext, a computer icon, and a web button; wherein the second menu hyperlinking means for hyperlinking to an Action Items subregion is selected from the group consisting of hypertext, a computer icon, and a web button; wherein the second menu hyperlinking means for hyperlinking to an ECO subregion is selected from the group consisting of hypertext, a computer icon, and a web button; wherein the second menu hyperlinking means for hyperlinking to an Equipment subregion is selected from the group consisting of hypertext, a computer icon, and a web button; wherein the second menu hyperlinking means for hyperlinking to a Building Personnel subregion is selected from the group consisting of hypertext, a computer icon, and a web button; wherein the second menu hyperlinking means for hyperlinking to a Maintenance Personnel subregion is selected from the group consisting of hypertext, a computer icon, and a web button; wherein the second menu hyperlinking means for hyperlinking to a Floor Plans subregion is selected from the group consisting of hypertext, a computer icon, and a web button; wherein the second menu hyperlinking means for hyperlinking to a Schedule subregion is selected from the group consisting of hypertext, a computer icon, and a web button; wherein the second menu hyperlinking means for hyperlinking to an Emergency subregion is selected from the group consisting of hypertext, a computer icon, and a web button; wherein the second menu hyperlinking means for hyperlinking to a Utilities subregion is selected from the group consisting of hypertext, a computer icon, and a web button.

Optionally, wherein the Building System subregion displays information pertaining to heating and cooling systems of the at least one building, wherein the information pertaining to heating and cooling systems is selected from the group consisting of an identifier for the information pertaining to the heating and cooling systems for the at least one building, an air handler unit type, an air handler unit configuration, an indication whether an air handler unit comprises a reheat design, an indication whether an air handler unit comprises a cooling design, an indication whether an air handler unit comprises a heating design, a control system type, an IP address for monitoring an air handler unit, a location of an air handler unit, an area served by an air handler unit, a note pertaining to an air handler unit, a hyperlink to documents relating to an handler unit, a precautionary statement, a National Fire Protection Association rating, and combinations thereof, wherein precautionary statements are selected from the group consisting of danger, warning, caution, note and none;
wherein the Utilities subregion displays information pertaining to utilities for the at least one building, wherein the information pertaining to the utilities for the at least one building is selected from the group consisting of a utility type, a shut-off type, a list of associated buildings, a note, a precautionary statement, a National Fire Protection Association rating, and combinations thereof, wherein precautionary statements are selected from the group consisting of danger, warning, caution, note and none;
wherein the Note subregion displays information pertaining to building operations and maintenance, wherein the information pertaining to building operations and maintenance is selected from the group consisting of a note type, a description, a priority, a responsible organization, a status, a status date, a completion date, a person assigned, a role, an assign date, a reminder, a precautionary statement, a National Fire Protection Association rating, and combinations thereof, wherein precautionary statements are selected from the group consisting of danger, warning, caution, note and none; wherein the note type is selected from the group consisting of Building Knowledge, Critical Knowledge, Action Items, ECO, Wish List, Space, Utilities, Asset and Building System;
wherein the Equipment subregion displays information pertaining to equipment situated in the at least one building, wherein the information pertaining to equipment situated in the at least one building is selected from the group consisting of an equipment description, a major tag, a sub-location, a hyperlink to documents pertaining to equipment situated in the at least one building, a precautionary statement, a National Fire Protection Association rating, and combinations thereof, wherein precautionary statements are selected from the group consisting of danger, warning, caution, note and none;
wherein the Asset subregion displays information pertaining to assets situated in the first building, wherein information pertaining to assets situated in the first building is selected from the group consisting of a short description, a category, a note, a precautionary statement, a National Fire Protection Association rating, and combinations thereof, wherein precautionary statements are selected from the group consisting of danger, warning, caution, note and none;
wherein the Action Items subregion displays information pertaining to outstanding maintenance issues for the at least one building, wherein the information pertaining to outstanding maintenance issues for the at least one building is selected from the group consisting of an action item identifier, a note type, a status, a start date, a finish date, a short description of an action item, a note, a category, a category detail, a timing, an occupancy, a responsible organization, a priority, a checklist to identify an ECO, a hyperlink to documents pertaining to an action item, a precautionary statement, a National Fire Protection Association rating, and combinations thereof, wherein precautionary statements are selected from the group consisting of danger, warning, caution, note and none;
wherein the ECO subregion displays information pertaining to Energy Conservation Opportunities for the at least one building, wherein the information pertaining to ECO for the at least one building is selected from the group consisting of an identifier for the information pertaining to the ECO for the at least one building, a note type, a status, a short description, a note, a category, a category detail, a timing, an occupancy, a responsible organization, a priority, a checkbox to indicate an ECO, a hyperlink to documents pertaining to Energy Conservation Opportunities in the at least one building, a precautionary statement, a National Fire Protection Association rating, and combinations thereof, wherein precautionary statements are selected from the group consisting of danger, warning, caution, note and none;
wherein the Building Personnel subregion displays information pertaining to administrative personnel associated with the at least one building, wherein the information pertaining to administrative personnel associated with the at least one building is selected from the group consisting of a first name, a last name, a telephone number, an email address, a position in an organization, a comment, a precautionary statement, a National Fire Protection Association rating, and combinations thereof, wherein precautionary statements are selected from the group consisting of danger, warning, caution, note and none;
wherein the Maintenance Personnel subregion displays information pertaining to maintenance personnel associated with the at least one building, wherein the information pertaining to maintenance personnel associated with the at least one building is selected from the group consisting of a first name, a last name, a telephone number, an email address, a position in an organization, a comment pertaining to a maintenance personnel for the at least one building, a precautionary statement, a National Fire Protection Association rating, and combinations thereof, wherein precautionary statements are selected from the group consisting of danger, warning, caution, note and none;
wherein the Floor Plans subregion displays information pertaining to floor plans and infrastructure plans for the at least one building, wherein the information pertaining to floor plans and infrastructure plans for the at least one building is selected from the group consisting of a floor, a plan type, a description pertaining to floor plans and infrastructure plans for the at least one building, a precautionary statement, a National Fire Protection Association rating, and combinations thereof, wherein precautionary statements are selected from the group consisting of danger, warning, caution, note and none;
wherein the Schedule subregion displays information pertaining to an occupancy schedule of the at least one building, wherein the information pertaining to the occupancy schedule of the at least one building is selected from the group consisting of a schedule, and a note pertaining to occupancy, a precautionary statement, a National Fire Protection Association rating, and combinations thereof, wherein precautionary statements are selected from the group consisting of danger, warning, caution, note and none;
wherein the Emergency subregion displays information pertaining to emergency procedures for the at least one building, wherein the information pertaining to the emergency procedures for the at least one building is selected from the group consisting of access, assets and threats, personnel, floor plans, a precautionary statement, a National Fire Protection Association rating, and combinations thereof, wherein precautionary statements are selected from the group consisting of danger, warning, caution, note and none.

Optionally: the Critical Knowledge subregion further displays a hyperlinking means for hyperlinking to the Input region, the Building Knowledge subregion further displays a hyperlinking means for hyperlinking to the Input region, the Building System subregion further displays a hyperlinking means for hyperlinking to the Input region, the Action Items subregion further displays a hyperlinking means for hyperlinking to the Input region, the Energy Conservation Opportunity (ECO) subregion further displays a hyperlinking means for hyperlinking to the Input region, the Equipment subregion further displays a hyperlinking means for hyperlinking to the Input region, the Building Personnel subregion further displays a hyperlinking means for hyperlinking to the Input region, the Maintenance Personnel subregion further displays a hyperlinking means for hyperlinking to the Input region, the Floor Plans subregion further displays a hyperlinking means for hyperlinking to the Input region, the Schedule subregion further displays a hyperlinking means for hyperlinking to the Input region, the Emergency subregion further displays a hyperlinking means for hyperlinking to the Input region, and the Utilities subregion further displays a hyperlinking means for hyperlinking to the Input region.

Optionally, the database comprises at least one database table, wherein different fields within the at least one database table are associable with different user access levels.

Optionally, the embodiments of the invention comprise a method for generating and display an electronic graphical user interface for permitting a user to interface with an electronic database configured to store information about a building or buildings, the method utilizing an electronic computer processor, a volatile electronic computer memory and a non-volatile electronic computer memory in communication with the electronic computer processor, and an electronic display device for displaying the electronic graphical user interface wherein the electronic display device is in electronic communication with the electronic computer processor and the volatile and non-volatile electronic computer memories, the method comprising:
generating a means for enabling a user to select at least one building from a plurality of buildings, the means for enabling a user to select at least one building from a plurality of buildings comprising a portion of the electronic graphical user interface;
displaying, in the electronic display device, the means for enabling a user to select at least one building from a plurality of buildings;
generating a first menu displaying: a first menu hyperlinking means for hyperlinking to a Buildings region, and a first menu hyperlinking means for hyperlinking to an Input region; wherein the first menu comprises a portion of the electronic graphical user interface;
displaying, in the electronic display device, the first menu;
generating within the Buildings region a second menu displaying a second menu hyperlinking means for hyperlinking to a Critical Knowledge subregion, wherein the second menu comprises a portion of the electronic graphical user interface;
displaying, in the electronic display device, the second menu;
generating the Critical Knowledge subregion comprising a portion of the electronic graphical user interface, wherein the Critical Knowledge subregion displays information pertaining to critical operational metadata for the at least one building, wherein the Critical Knowledge subregion further displays a hyperlinking means for hyperlinking to the Input region, the second menu further displaying a second menu hyperlinking means for hyperlinking to: a Building Knowledge subregion displaying building metadata and device metadata for the at least one building, a Building System subregion, an Action Items subregion, an Energy Conservation Opportunity (ECO) subregion, an Equipment subregion, a Building Personnel subregion, a Maintenance Personnel subregion, a Floor Plans subregion, a Schedule subregion, an Emergency subregion, a Note subregion, an Asset subregion, and a Utilities subregion;
displaying, in the electronic display device, the Critical Knowledge subregion; generating the Input region comprising a portion of the electronic graphical user interface, the Input region comprising a plurality of controls for enabling a user to input data into the electronic database, the plurality of controls comprising: a means for enabling a user to specify a second building, a means for enabling a user to specify a second space located within the second building, a means for enabling a user to specify at least one subregion pertaining to the second space, a means for enabling a user to specify at least one attribute type of the at least one subregion pertaining to the second space;
displaying, in the electronic display device, the input region.

Optionally, the means for enabling a user to specify a second space located within the second building is selected from the group consisting of a text entry box, a radio button, a computer icon, and a pull-down menu; wherein a specification of the second space is selected from the group consisting of a space name, a space type, metadata regarding the space, a precautionary statement, a National Fire Protection Association rating, a building floor, a compass direction, a room number, a key number, an indication for whether the space has a proxy access, an indication for whether the space has a key card access, an indication for whether the space is alarmed, an indication for whether the space is an emergency exit, an indication for whether the space is an elevator, an indication for whether the space is a stairwell an indication for whether the space is a building exit, an indication for whether the space is a main shut-off for a utility, and combinations thereof; wherein precautionary statements are selected from the group consisting of danger, warning, caution, note and none.

Optionally, the non-volatile memory contains code configured to cause: any precautionary statement designated at a level above note to be displayed at least in the Emergency subregion; any National Fire Protection Agency rating designated at a rating greater than zero to be displayed at least in the Emergency subregion and in the Critical Knowledge subregion; any information designated as a utility category type to be displayed at least in the Emergency subregion and the Utilities subregion; any information designated with a start date and an end date to be displayed at least in the Action Item subregion; any information designated as an ECO to be displayed at least in the ECO subregion; any information designated as a Building System to be displayed at least in the Building System subregion; any information designated as equipment to be displayed at least in the Equipment subregion; any information designated as building personnel to be displayed at least in the Building Personnel subregion; any information designated as maintenance personnel to be displayed at least in the Maintenance Personnel subregion; any information designated as floor plans to be displayed at least in the Floor Plans subregion; any information designated as a schedule to be displayed at least in the Schedule subregion; all information not displayed in the Critical Knowledge subregion or the Emergency subregion to be displayed at least in the Building Knowledge subregion; any note type that is designated as Building Knowledge to be displayed in the Building Knowledge subregion; any note type designated as Critical Knowledge to be displayed in the Critical knowledge subregion; any note type designated as an Action Item to be displayed in the Action Items subregion; and any note type designated as a Wish List to be displayed in the Wish List subregion.

Some Advantages of the Embodiments of the Invention

The embodiments of the present invention integrate previously unintegrated information.

These and other advantages will become apparent as the embodiments of the invention are used.

### DRAWINGS

These and other features, aspects and advantages of the embodiments of the method will become better understood with reference to the following description, appended claim and accompanying drawings where:

FIG. 1 shows a schematic representation of an embodiment of the first menu of the graphical user interface (GUI), also showing an embodiment of the means for selecting at least one building;

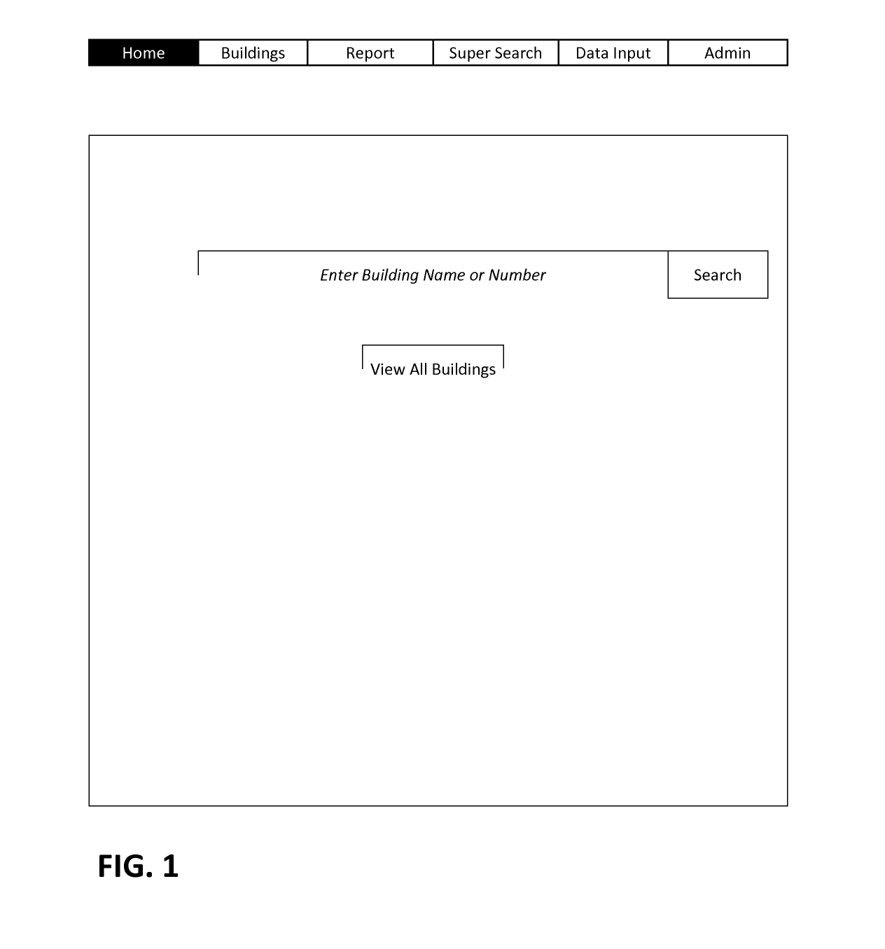

FIG. 2 shows a schematic representation of an embodiment of the second menu of the GUI;

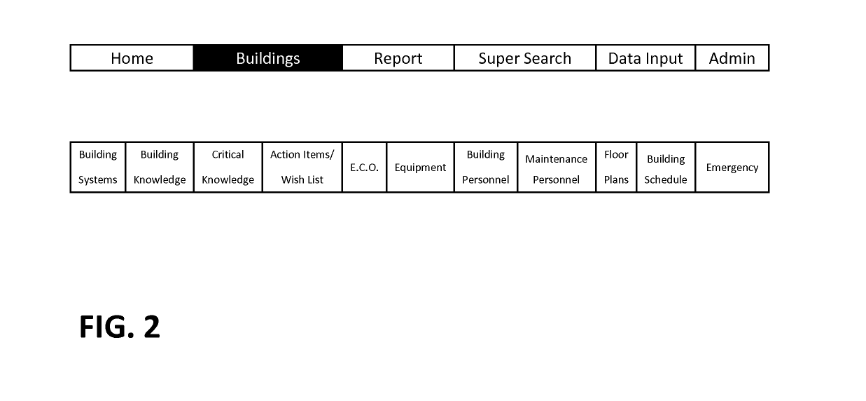

FIG. 3 shows a schematic representation of an embodiment of the GUI means for enabling a user to specify a second space;

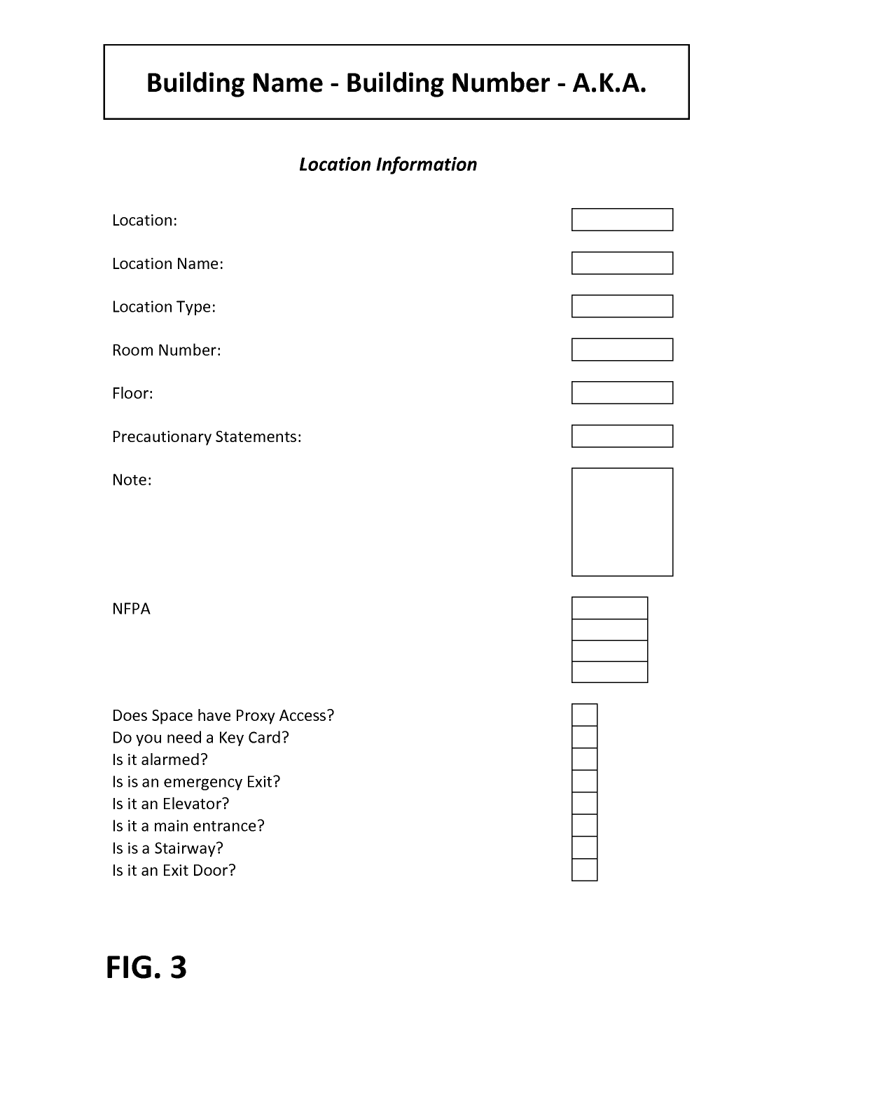

FIG. 4 shows a schematic representation of an embodiment of the Report subregion of the GUI;

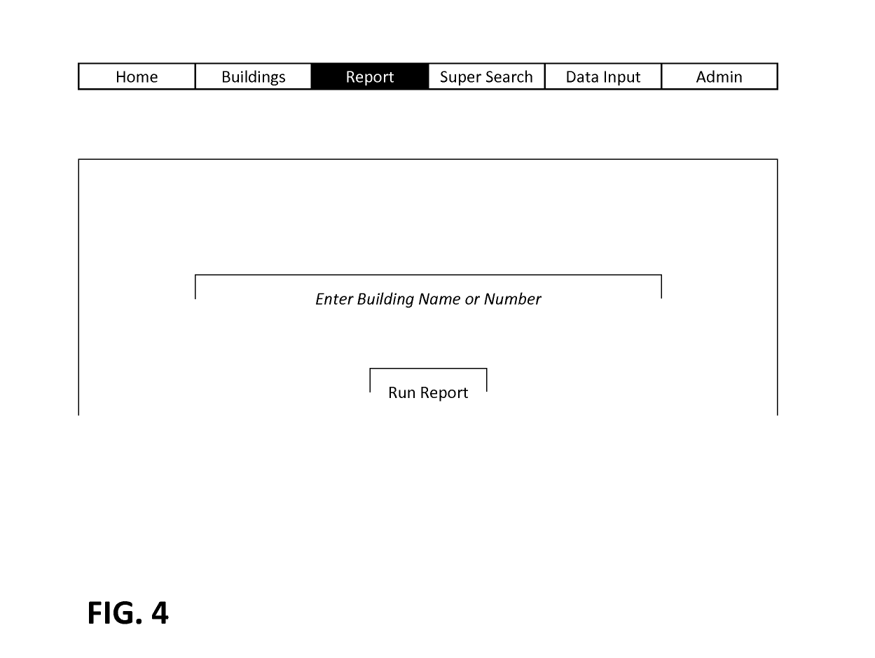

FIG. 5 shows a schematic representation of an embodiment of the Super Search subregion of the GUI;

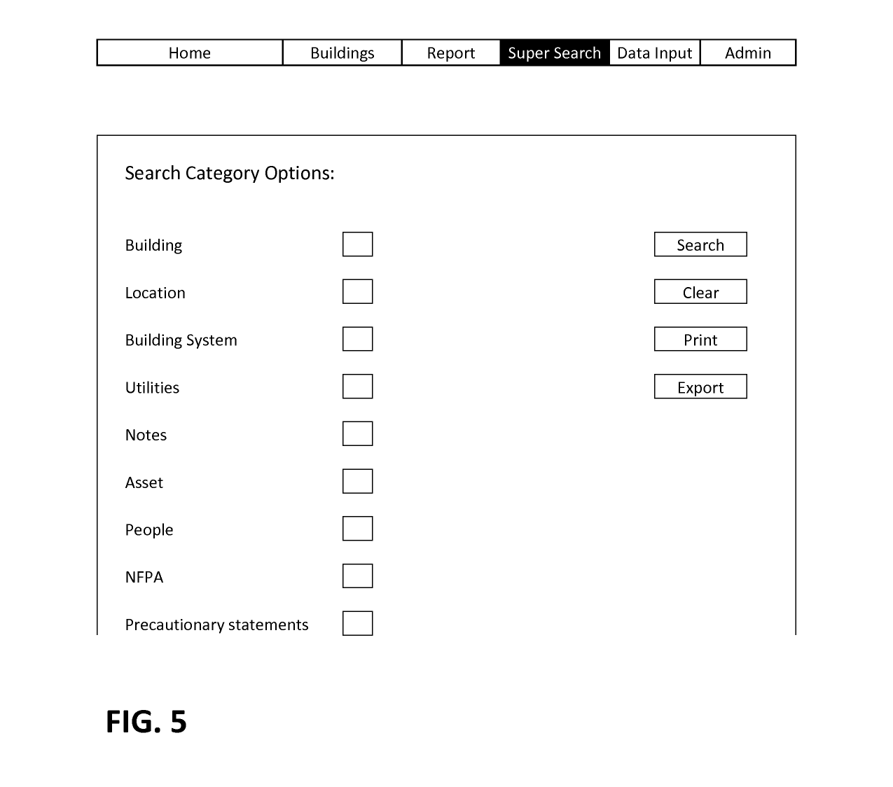

FIG. 6 shows a schematic representation of an embodiment of the Data Input subregion of the GUI;

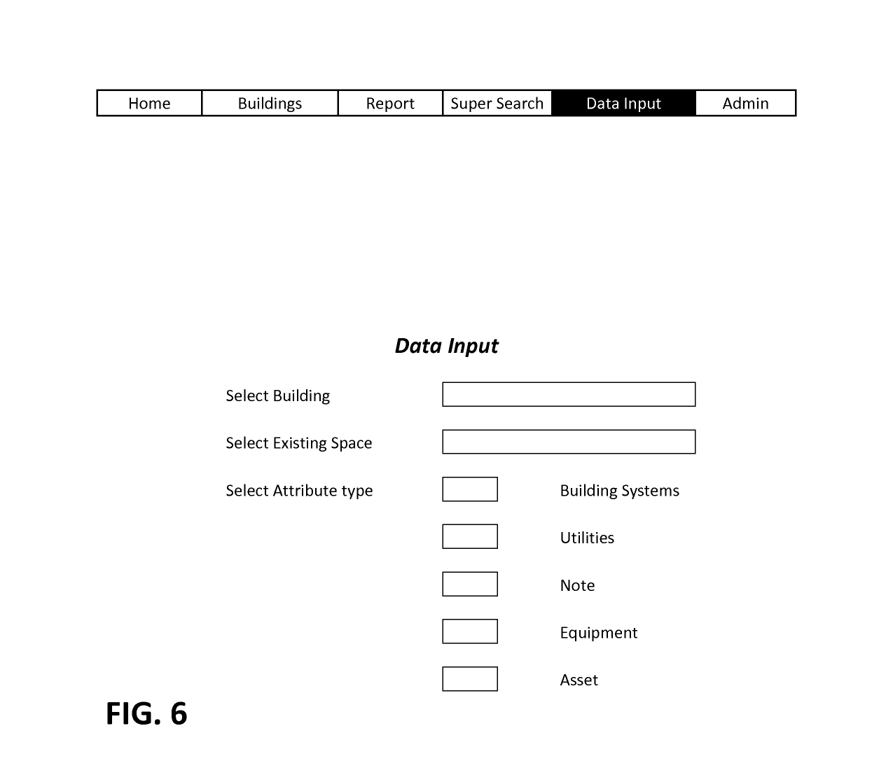

FIG. 7 shows a schematic representation of an embodiment of the Building System input subregion of the GUI;

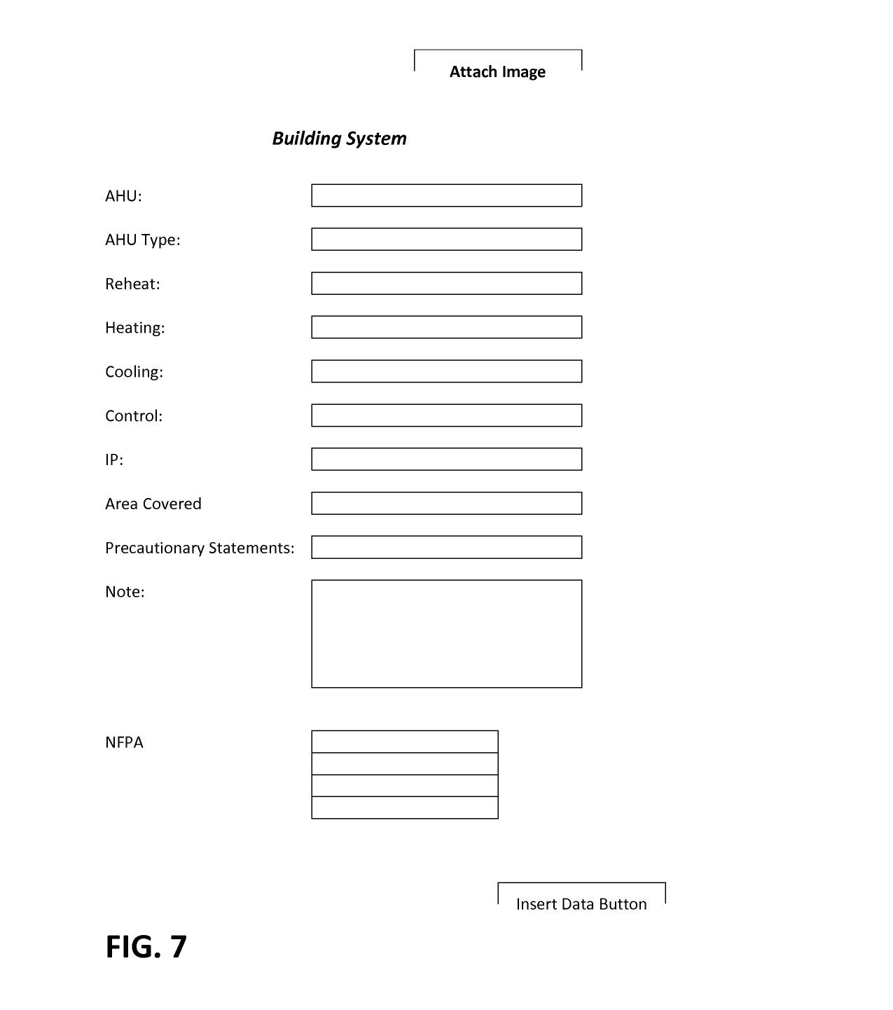

FIG. 8 shows a schematic representation of an embodiment of the Equipment input subregion of the GUI;

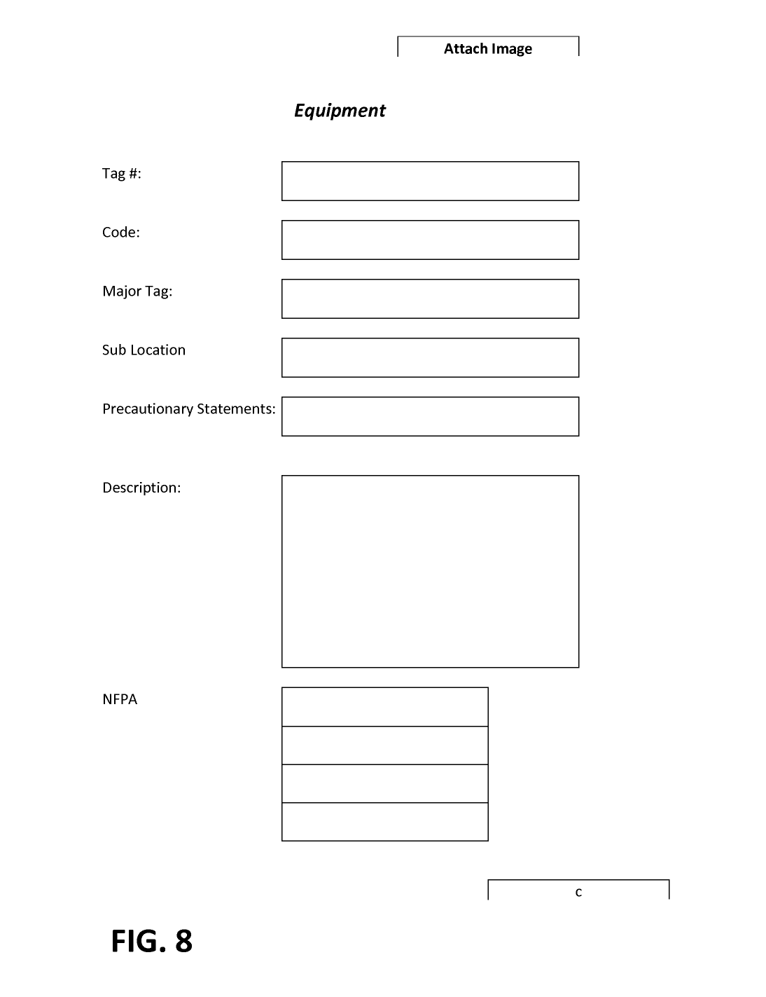

FIG. 9 shows a schematic representation of an embodiment of the Asset input subregion of the GUI;

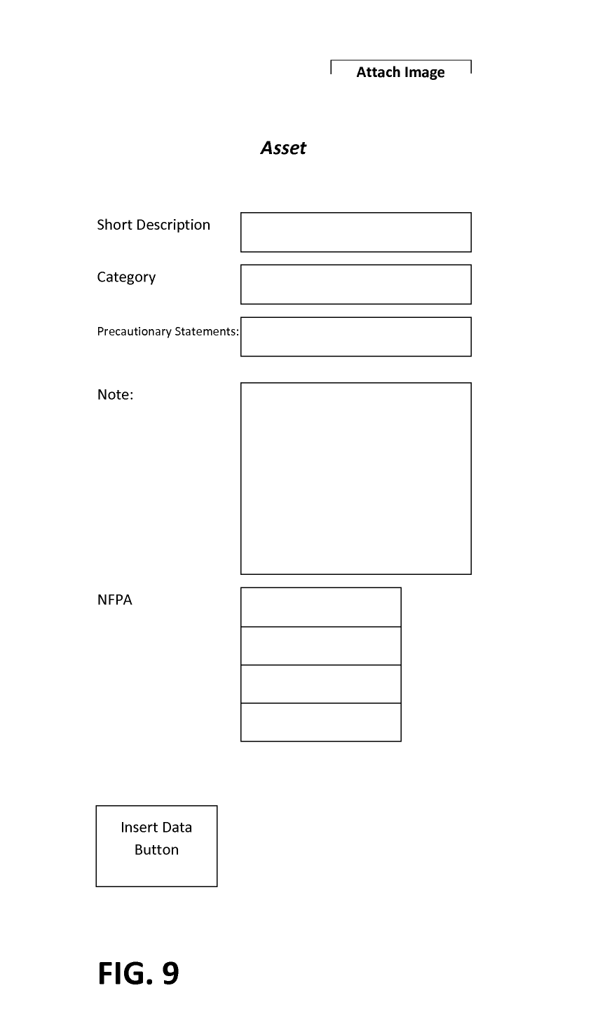

FIG. 10 shows a schematic representation of an embodiment of the Notes input subregion of the GUI;

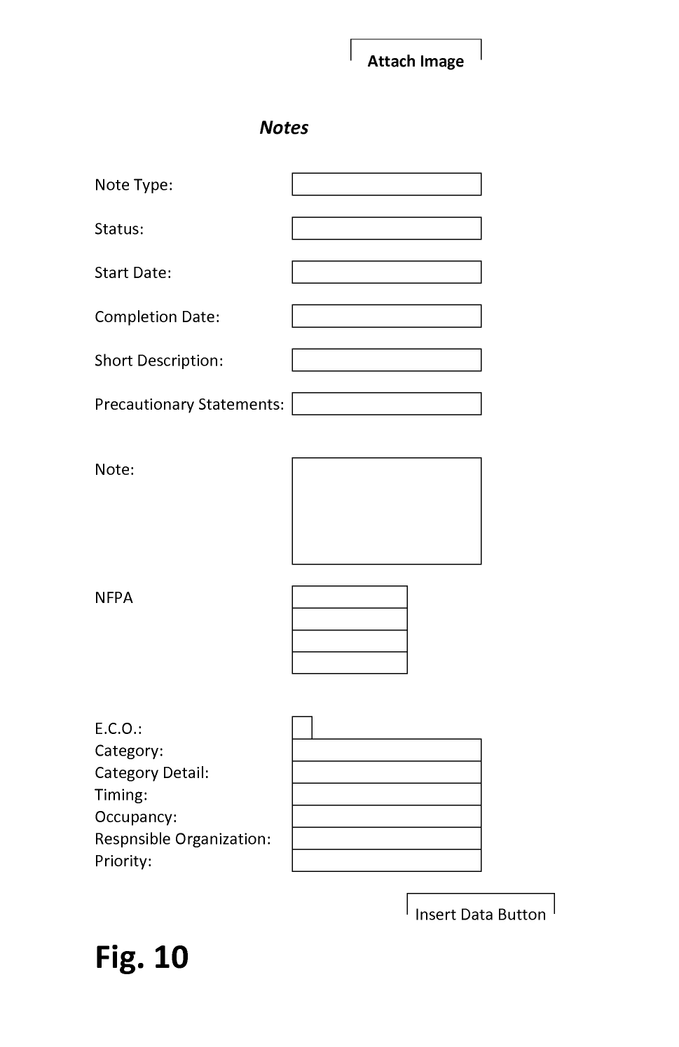

FIG. 11 shows a schematic representation of an embodiment of the Utilities input subregion of the GUI;

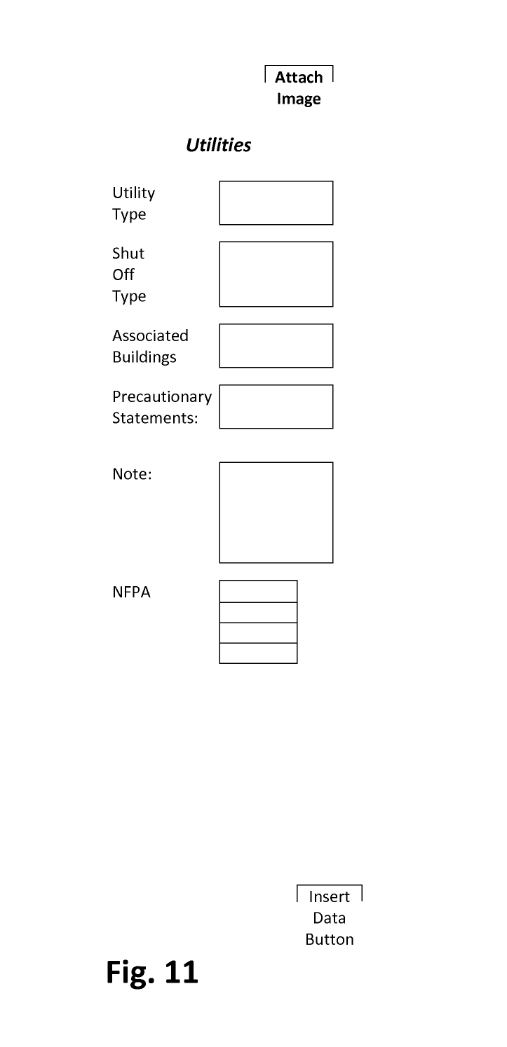

FIG. 12 shows a schematic representation of an embodiment of the Administration subregion of the GUI.

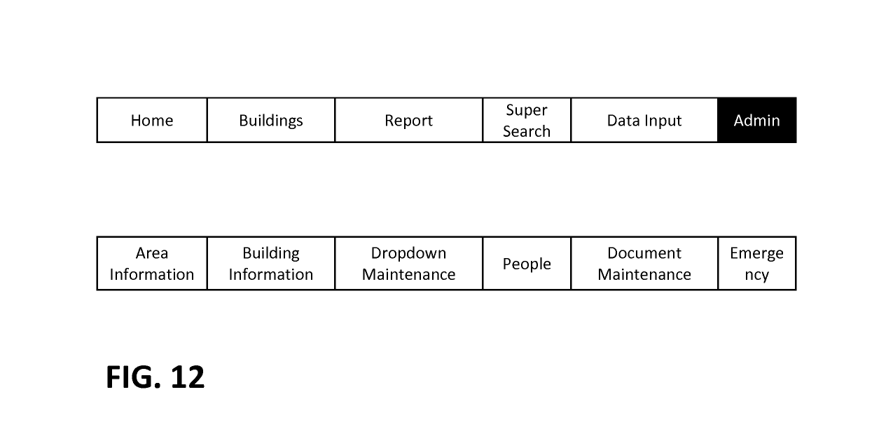

Reference Numerals for Drawings:

### None.

### DESCRIPTION

### Definitions

According to U.S. Pat. No. 8,352,472, “Generally, metadata refers to data or information about data . . . ”

U.S. Pat. No. 7,668,990 specifically defines “device metadata” as “basic operational information or idiosyncrasies about each [new] device.” According to U.S. Pat. No. 8,352,492, “Metadata may include, as examples, one or more graphical illustrations of the device, the manufacturer's name, information about the device's features, and/or available user configuration tasks and various parameters relating to these tasks.” According to U.S. Pat. No. 7,129,855, device metadata “is data relating to the unique control behaviors of a particular [CE] device.”

“Building metadata” in the present document comprises “lessons learned” about operating the building, i.e., idiosyncrasies that are otherwise known only to experienced operators of the building. It also comprises locations of components such as mechanical rooms and air handler units, guidelines on what to audit or monitor, which sensors control what, insights or other knowledge considered important by an operator, and the like.

Device metadata relating to a selected building means metadata on devices located in the specified building.

Critical operational metadata comprises locations of and information regarding critical operational components such as main shut-off valves for water and gas, sewer ejector pumps, electrical panels, emergency generators, fire protection valves, and the like. It relates to activities that are happening within the building, such as animal colonies, storage of highly volatile materials and the systems that support them.

Emergency metadata comprises building identification information, lists of responsible personnel, public relations plans, property and asset and location priorities, emergency plans, access plans and codes and protocols, and the like.

Precautionary statements comprise danger/warning/caution/note/none statements. A precautionary statement at a level above note is a statement of danger, warning or caution.

Executable instructions are procedures that are not self-executing but must be implemented by operations personnel.

A specification of a space comprises a description of a space, its location, and how to get into it. Thus it is necessary to know where a space is; if it alarmed, and what the alarm code is; and the like.

Types of attributes comprise buildings systems, utilities, assets, equipment, and notes.

National Fire Protection Association (NFPA) ratings advise emergency response personnel via the hazard diamond sticker of hazards they may encounter when entering the room in response to fire or other situations. According to Wikipedia (http://en.wikipedia.org/wiki/NFPA_{—}704),

“NFPA 704: Standard System for the Identification of the Hazards of Materials for Emergency Response is a standard maintained by the U.S.-based National Fire Protection Association. First “tentatively adopted as a guide” in 1960, and revised several times since then, it defines the colloquial “fire diamond” used by emergency personnel to quickly and easily identify the risks posed by hazardous materials. This helps determine what, if any, special equipment should be used, procedures followed, or precautions taken during the initial stages of an emergency response . . . . The four divisions are typically color-coded, with blue indicating level of health hazard, red indicating flammability, yellow (chemical) reactivity, and white containing special codes for unique hazards. Each of health, flammability and reactivity is rated on a scale from 0 (no hazard) to 4 (severe risk).”

A region is a major division of a website. A subregion is a minor division of a website.

According to Wikipedia, (http://en.wikipedia.org/wiki/Computer_memory), volatile memory is defined as follows: “Volatile memory is computer memory that requires power to maintain the stored information. Most modern semiconductor volatile memory is either Static RAM (see SRAM) or dynamic RAM (see DRAM). SRAM retains its contents as long as the power is connected and is easy to interface to but uses six transistors per bit. Dynamic RAM is more complicated to interface to and control and needs regular refresh cycles to prevent its contents being lost. However, DRAM uses only one transistor and a capacitor per bit, allowing it to reach much higher densities and, with more bits on a memory chip, be much cheaper per bit. SRAM is not worthwhile for desktop system memory, where DRAM dominates, but is used for their cache memories. SRAM is commonplace in small embedded systems, which might only need tens of kilobytes or less. Forthcoming volatile memory technologies that hope to replace or compete with SRAM and DRAM include Z-RAM, TTRAM, A-RAM and ETA RAM.”

According to Wikipedia, (http://en.wikipedia.org/wiki/Computer_memory), non-volatile memory is defined as follows: “Non-volatile memory is computer memory that can retain the stored information even when not powered. Examples of non-volatile memory include read-only memory (see ROM), flash memory, most types of magnetic computer storage devices (e.g. hard disks, floppy discs and magnetic tape), optical discs, and early computer storage methods such as paper tape and punched cards. Forthcoming non-volatile memory technologies include FeRAM, CBRAM, PRAM, SONOS, RRAM, Racetrack memory, NRAM and Millipede.”

According to Wikipedia (http://en.wikipedia.org/wiki/Graphical_user_interface), “In computing, graphical user interface (GUI) is a type of user interface that allows users to interact with electronic devices using images rather than text commands. GUIs can be used in computers, hand-held devices such as MP3 players, portable media players or gaming devices, household appliances, office and industry equipment. A GUI represents the information and actions available to a user through graphical icons and visual indicators such as secondary notation, as opposed to text-based interfaces, typed command labels or text navigation. The actions are usually performed through direct manipulation of the graphical elements. The term GUI is restricted to the scope of two-dimensional display screens with display resolutions able to describe generic information, in the tradition of the computer science research at the PARC (Palo Alto Research Center). The term GUI is rarely applied to other low-resolution types of interfaces that are non-generic, such as video games (where HUD is preferred), or not restricted to flat screens, like volumetric displays.”

A menu is an array of links. Menus can be implemented as navigation bars. According to Wikipedia (http://en.wikipedia.org/wiki/Navigation_bar),

“A navigation bar or (navigation system) is a section of a website or online page intended to aide visitors in travelling through the online document. Typically, webpages will have a primary navigation bar and a secondary navigation bar on all pages of the web document. These sections of the webpage will include links to the most important sections of the site. The implementation and design of navigation bars is a crucial aspect of web design and web usability.”

According to Wikipedia (http://en.wikipedia.org/wiki/Computer_icon), “A computer icon is a pictogram displayed on a computer screen and used to navigate a computer system or mobile device. The icon itself is a small picture or symbol serving as a quick, “intuitive” representation of a software tool, function or a data file accessible on the system. It functions as an electronic hyperlink or file shortcut to access the program or data. Computer icons, in conjunction with computer windows, menus and a pointing device, form the graphical user interface (GUI) of the computer system, and enable the user to easily and intuitively navigate the system. Computer icons belong to the much larger topic of the history of the graphical user interface.”

According to Wikipedia (http://en.wikipedia.org/wiki/Hyperlink),

“In computing, a hyperlink (or link) is a reference to data that the reader can directly follow, or that is followed automatically. A hyperlink points to a whole document or to a specific element within a document. Hypertext is text with hyperlinks. A software system for viewing and creating hypertext is a hypertext system, and to create a hyperlink is to hyperlink (or simply to link). A user following hyperlinks is said to navigate or browse the hypertext.
A hyperlink has an anchor, which is the location within a certain type of a document from which the hyperlink can be followed only from the homepage; the document containing a hyperlink is known as its source code document. For example, in an online reference work such as Wikipedia, many words and terms in the text are hyperlinked to definitions of those terms. Hyperlinks are often used to implement reference mechanisms, such as tables of contents, footnotes, bibliographies, indexes, letters, and glossaries.
In some hypertext, hyperlinks can be bidirectional: they can be followed in two directions, so both ends act as anchors and as targets. More complex arrangements exist, such as many-to-many links.
The effect of following a hyperlink may vary with the hypertext system and may sometimes depend on the link itself; for instance, on the World Wide Web, most hyperlinks cause the target document to replace the document being displayed, but some are marked to cause the target document to open in a new window. Another possibility is transclusion, for which the link target is a document fragment that replaces the link anchor within the source document. Not only persons browsing the document follow hyperlinks; they may also be followed automatically by programs. A program that traverses the hypertext, following each hyperlink and gathering all the retrieved documents is known as a Web spider or crawler.”

According to Wikipedia (http://en.wikipedia.org/wiki/Web_button),

“Web buttons, button graphics, web badges or stickers are pictures in some World Wide Web pages which are typically used to advertise programs that were used to create or host the site (for example, MediaWiki sites often have a “Powered by Mediawiki” button on the bottom right corner of the page), programs that are recommended to view the site, or that the site passes World Wide Web Consortium (W3C) HTML validation.
The buttons are linked to the advertised sites. These were first popularized as “Best viewed in . . . ” buttons by Netscape and Microsoft during the browser wars.”

According to Wikipedia (http://en.wikipedia.org/wiki/Text_box),

“A text box, text field or text entry box is a kind of widget used when building a graphical user interface (GUI). A text box's purpose is to allow the user to input text information to be used by the program. User-interface guidelines recommend a single-line text box when only one line of input is required, and a multi-line text box only if more than one line of input may be required. Non-editable text boxes can serve the purpose of simply displaying text.
A typical text box is a rectangle of any size, possibly with a border that separates the text box from the rest of the interface. Text boxes may contain zero, one, or two scrollbars. Text boxes usually display a text cursor (commonly a blinking vertical line), indicating the current region of text being edited. It is common for the mouse cursor to change its shape when it hovers over a text box.”

According to Wikipedia (http://en.wikipedia.org/wiki/Checkbox),

“In computing, a checkbox (check box, tickbox, or tick box) is a graphical user interface element (widget) that permits the user to make multiple selections from a number of options (contrary to a radio button where only one choice is possible) or to have the user answer yes (checked) or no (not checked) on a simple yes/no question.
Normally, checkboxes are shown on the screen as a square box that can contain white space (for false) or a tick mark or X (for true), as pictured. A caption describing the meaning of the checkbox is normally shown adjacent to the checkbox. Inverting the state of a checkbox is done by clicking the mouse on the box, or the caption, or by using a keyboard shortcut, such as the space bar.”

According to Wikipedia (http://en.wikipedia.org/wiki/Menu_bar),

“A menu bar is a region of a screen or application interface where drop down menus are displayed. The menu bar's purpose is to supply a common housing for window- or application-specific menus which provide access to such functions as opening files, interacting with an application, or displaying help documentation or manuals. Menu bars are typically present in graphical user interfaces that display documents and representations of files in windows and windowing systems but menus can be used as well in command line interface programs like text editors or filemanagers where drop-down menu is activated with shortcut key or combination.”

According to Wikipedia (http://en.wikipedia.org/wiki/Pull-down_menu),

“A computer using a graphical user interface presents menus with a combination of text and symbols to represent choices. By clicking on one of the symbols or text, the operator is selecting the instruction that the symbol represents. A context menu is a menu in which the choices presented to the operator are automatically modified according to the current context in which the operator is working.
A common use of menus is to provide convenient access to various operations such as saving or opening a file, quitting a program, or manipulating data. Most widget toolkits provide some form of pull-down or pop-up menu. Pull-down menus are the type commonly used in menu bars (usually near the top of a window or screen), which are most often used for performing actions, whereas pop-up (or “fly-out”) menus are more likely to be used for setting a value, and might appear anywhere in a window.”

According to Wikipedia (http://en.wikipedia.org/wiki/Database),

“A database is an organized collection of data. The data is typically organized to model relevant aspects of reality (for example, the availability of rooms in hotels), in a way that supports processes requiring this information (for example, finding a hotel with vacancies).
The term database is correctly applied to the data and their supporting data structures, and not to the database management system (DBMS). The database data collection with DBMS is called a database system.
The term database system implies that the data is managed to some level of quality (measured in terms of accuracy, availability, usability, and resilience) and this in turn often implies the use of a general-purpose database management system (DBMS). A general-purpose DBMS is typically a complex software system that meets many usage requirements to properly maintain its databases which are often large and complex.
This is specially the case with client-server, near-real time transactional systems, in which multiple users have access to data, data is concurrently entered and inquired for in ways that preclude single-thread batch processing. Most of the complexity of those requirements are still present with personal, desktop-based database systems.
Well known DBMSs include Oracle, Sybase, FoxPro, IBM DB2, Linter, Microsoft Access, Microsoft SQL Server, MySQL, PostgreSQL and SQLite. A database is not generally portable across different DBMS, but different DBMSs can inter-operate to some degree by using standards like SQL and ODBC together to support a single application built over more than one database. A DBMS also needs to provide effective run-time execution to properly support (e.g., in terms of performance, availability, and security) as many database end-users as needed. A way to classify databases involves the type of their contents, for example: bibliographic, document-text, statistical, or multimedia objects. Another way is by their application area, for example: accounting, music compositions, movies, banking, manufacturing, or insurance. The term database may be narrowed to specify particular aspects of organized collection of data and may refer to the logical database, to the physical database as data content in computer data storage or to many other database sub-definitions.”

According to Wikipedia (http://en.wikipedia.org/wiki/Field_(computer_science)), “In computer science, data that has several parts can be divided into fields. Relational databases arrange data as sets of database records, also called rows. Each record consists of several fields; the fields of all records form the columns.”

A user's electronic computing device includes but is not limited to a desktop computer, a portable computer such as a laptop or notebook, a tablet, and a smartphone.

Pot feeders are a means of chemically treating pipes in a closed-loop system.

ECO is Energy Conservation Opportunity.

Air handler unit types comprise variable air volume and constant air volume.

Air handler unit configurations comprise horizontal draw-through, vertical draw-through, stacked draw-through, horizontal blow-through, and stacked heat recovery.

### DESCRIPTION OF THE PREFERRED EMBODIMENT AND BEST MODE

As shown in the figures, the preferred embodiment and best mode of the present invention comprise an electronic programmable apparatus to generate an electronic graphical user interface for permitting a user to interface with an electronic database configured to store information about a building or buildings, the apparatus comprising: an electronic computer processor, a volatile electronic computer memory and a non-volatile electronic computer memory in communication with the electronic computer processor, and an electronic display device for displaying the electronic graphical user interface wherein the electronic display device is in electronic communication with the electronic computer processor and the volatile and non-volatile electronic computer memories;

the electronic graphical user interface comprising:
a means for enabling a user to select at least one building from a plurality of buildings;
a first menu displaying: a first menu hyperlinking means for hyperlinking to a Buildings region, and a first menu hyperlinking means for hyperlinking to an Input region;
the Buildings region comprising a second menu displaying a second menu hyperlinking means for hyperlinking to a Critical Knowledge subregion, wherein the Critical Knowledge subregion displays information pertaining to critical operational metadata for the at least one building, the second menu further displaying a second menu hyperlinking means for hyperlinking to: a Building Knowledge subregion displaying building metadata and device metadata for the at least one building, a Building System subregion, an Action Items subregion, an Energy Conservation Opportunity (ECO) subregion, an Equipment subregion, a Building Personnel subregion, a Maintenance Personnel subregion, a Floor Plans subregion, a Schedule subregion, an Emergency subregion, a note subregion, an Asset subregion, and a Utilities subregion;
the Input region displaying a plurality of controls for enabling a user to input data into the electronic database, the plurality of controls comprising: a means for enabling a user to specify a second building, a means for enabling a user to specify a second space located within the second building, a means for enabling a user to specify at least one subregion pertaining to the second space, a means for enabling a user to specify at least one attribute type of the at least one subregion pertaining to the second space.

Optionally, the first menu hyperlinking means for hyperlinking to an Input region is selected from the group consisting of hypertext, a computer icon, and a web button.

Optionally, the means for enabling a user to specify a second building is selected from the group consisting of a text entry box, a radio button, a computer icon, and a pull-down menu.

Optionally, the means for enabling a user to specify a second space located within the second building is selected from the group consisting of a text entry box, a radio button, a computer icon, and a pull-down menu; wherein a specification of the second space is selected from the group consisting of a space name, a space type, metadata regarding the space, a precautionary statement, a National Fire Protection Association rating, a building floor, a compass direction, a room number, a key number, an indication for whether the space has a proxy access, an indication for whether the space has a key card access, an indication for whether the space is alarmed, an indication for whether the space is an emergency exit, an indication for whether the space is an elevator, an indication for whether the space is a stairwell an indication for whether the space is a building exit, an indication for whether the space is a main shut-off for a utility, and combinations thereof; wherein precautionary statements are selected from the group consisting of danger, warning, caution, note and none.

Optionally, the means for enabling a user to specify at least one subregion pertaining to the second space comprises a plurality of buttons wherein each button corresponds to a subregion.

Optionally, the means for enabling a user to specify at least one attribute type of the at least one subregion pertaining to the second space is selected from the group consisting of a hyperlinking means for hyperlinking to a Building System input subregion, a hyperlinking means for hyperlinking to a Utility input subregion, a hyperlinking means for hyperlinking to a Note input subregion, a hyperlinking means for hyperlinking to an Equipment input subregion, a hyperlinking means for hyperlinking to an Asset input subregion, and combinations thereof; wherein the hyperlinking means for hyperlinking to a Building System input subregion is selected from the group consisting of hypertext, a computer icon, and a web button; wherein the hyperlinking means for hyperlinking to a Utility input subregion is selected from the group consisting of hypertext, a computer icon, and a web button; wherein the hyperlinking means for hyperlinking to a Note input subregion is selected from the group consisting of hypertext, a computer icon, and a web button; wherein the hyperlinking means for hyperlinking to an Equipment input subregion is selected from the group consisting of hypertext, a computer icon, and a web button; wherein the hyperlinking means for hyperlinking to an Asset input subregion is selected from the group consisting of hypertext, a computer icon, and a web button.

Optionally, the Building System input subregion displays a means for inputting information pertaining to heating and cooling systems of the at least one building, wherein the information pertaining to heating and cooling systems is selected from the group consisting of an identifier for the information pertaining to the heating and cooling systems for the at least one building, an air handler unit type, an air handler unit configuration, an indication whether an air handler unit comprises a reheat design, an indication whether an air handler unit comprises a cooling design, an indication whether an air handler unit comprises a heating design, a control system type, an IP address for monitoring an air handler unit, a location of an air handler unit, an area served by an air handler unit, a note pertaining to an air handler unit, a hyperlink to documents relating to an handler unit, a precautionary statement, a National Fire Protection Association rating, and combinations thereof, wherein precautionary statements are selected from the group consisting of danger, warning, caution, note and none;
wherein the Utilities input subregion displays a means for inputting information pertaining to utilities for the at least one building, wherein the information pertaining to the utilities for the at least one building is selected from the group consisting of a utility type, a shut-off type, a list of associated buildings, a note, a precautionary statement, a National Fire Protection Association rating, and combinations thereof, wherein precautionary statements are selected from the group consisting of danger, warning, caution, note and none;
wherein the Note input subregion displays a means for inputting information pertaining to building operations and maintenance, wherein the information pertaining to building operations and maintenance is selected from the group consisting of a note type, a description, a priority, a responsible organization, a status, a status date, a completion date, a person assigned, a role, an assign date, a reminder, a precautionary statement, a National Fire Protection Association rating, and combinations thereof, wherein precautionary statements are selected from the group consisting of danger, warning, caution, note and none; wherein the note type is selected from the group consisting of Building Knowledge, Critical Knowledge, Action Items, ECO, Wish List, Space, Utilities, Asset and Building System;
wherein the Equipment input subregion displays a means for inputting information pertaining to equipment situated in the at least one building, wherein the information pertaining to equipment situated in the at least one building is selected from the group consisting of an equipment description, a major tag, a sub-location, a hyperlink to documents pertaining to equipment situated in the at least one building, a precautionary statement, a National Fire Protection Association rating, and combinations thereof, wherein precautionary statements are selected from the group consisting of danger, warning, caution, note and none;

wherein the Asset input subregion displays a means for inputting information pertaining to assets situated in the first building, wherein information pertaining to assets situated in the first building is selected from the group consisting of a short description, a category, a note, a precautionary statement, a National Fire Protection Association rating, and combinations thereof, wherein precautionary statements are selected from the group consisting of danger, warning, caution, note and none.

Optionally, the non-volatile memory contains code configured to cause: any precautionary statement designated at a level above note to be displayed at least in the Emergency subregion; any National Fire Protection Agency rating designated at a rating greater than zero to be displayed at least in the Emergency subregion and in the Critical Knowledge subregion; any information designated as a utility category type to be displayed at least in the Emergency subregion and the Utilities subregion; any information designated with a start date and an end date to be displayed at least in the Action Item subregion; any information designated as an ECO to be displayed at least in the ECO subregion; any information designated as a Building System to be displayed at least in the Building System subregion; any information designated as equipment to be displayed at least in the Equipment subregion; any information designated as building personnel to be displayed at least in the Building Personnel subregion; any information designated as maintenance personnel to be displayed at least in the Maintenance Personnel subregion; any information designated as floor plans to be displayed at least in the Floor Plans subregion; any information designated as a schedule to be displayed at least in the Schedule subregion; all information not displayed in the Critical Knowledge subregion or the Emergency subregion to be displayed at least in the Building Knowledge subregion; any note type that is designated as Building Knowledge to be displayed in the Building Knowledge subregion; any note type designated as Critical Knowledge to be displayed in the Critical knowledge subregion; any note type designated as an Action Item to be displayed in the Action Items subregion; and any note type designated as a Wish List to be displayed in the Wish List subregion.

Optionally, the information pertaining to critical operational metadata for the at least one building is selected from the group consisting of an identifier for the critical operation metadata for the at least one building, a short description of a subject to which the critical operational metadata pertains, a note containing the critical operational metadata, a category to which the critical operational metadata pertains, a category detail, a checkbox to indicate an ECO, and a hyperlink to documents pertaining to the critical operational metadata for the at least one building, and combinations thereof.

Optionally, the second menu hyperlinking means for hyperlinking to a Critical Knowledge subregion is selected from the group consisting of hypertext, a computer icon, and a web button.

Optionally, the category to which the critical operational metadata pertains is selected from the group consisting of electrical, plumbing, fire, and controls.

Optionally, the building and device metadata for the at least one building is selected from the group consisting of a description of the building metadata and device metadata for the at least one building, an identifier for the building metadata and device metadata for the at least one building, a device category, a category detail, a checkbox to indicate an ECO, a hyperlink to documents pertaining to the building metadata and device metadata for the at least one building, and combinations thereof.

Optionally, the first menu hyperlinking means for hyperlinking to a Buildings region is selected from the group consisting of hypertext, a computer icon, and a web button.

Optionally, the second menu hyperlinking means for hyperlinking to a Building Knowledge subregion is selected from the group consisting of hypertext, a computer icon, and a web button.

Optionally, the means for enabling a user to select at least one building from a plurality of buildings is selected from the group consisting of a text entry box, a radio button, a computer icon, and a pull-down menu.

Optionally, the first menu further displays a first menu hyperlinking means for hyperlinking to a Super Search region, wherein the Super Search region displays a menu for selecting for display a first set of information for one or more buildings.

Optionally, the first set of information comprises locations indicated on a digital map.

Optionally, the menu for selecting for display a first set of information for one or more buildings comprises a Building Super Search region, wherein the Building Super Search region comprises a means for selecting information pertaining to physical building characteristics; wherein the information pertaining to physical building characteristics is selected from the group consisting of a building, a building number, an area, an address, a city, a zip code, a square feet, a year built, a campus, a map grid, a schedule, a type, a tag number, a floor, a set of drawings, a drawing type, and combinations thereof;
wherein the menu for selecting for display a first set of information for one or more buildings further comprises a Control/System Super Search region; wherein the Control/System Super Search region comprises a means for selecting Building Controls, System Numbers, and Modes of Distribution, wherein Building Controls comprise control type and schedule and location, wherein System Numbers comprise numerical identifiers of system types and area covered, and wherein Modes of Distribution comprise air handler, mechanical, POT feeder, system type, and VFD;
wherein the menu for selecting for display a first set of information for one or more buildings further comprises a People Super Search region, wherein the People Super Search region comprises a means for selecting a name, an identification number, Contact Information, Building Positions, and Area Positions, wherein Contact Information comprises a contact type and a priority, wherein Building Positions comprises an inactive date and an active date range, wherein Area Positions comprises a position and an area assigned;
wherein the menu for selecting for display a first set of information for one or more buildings further comprises a Note Super Search region comprising a means for selecting information pertaining to building operations and maintenance, wherein the information pertaining to building operations and maintenance is selected from the group consisting of a note type, a description, a priority, a responsible organization, a status, a status date, a completion date, a person assigned, a role, an assign date, a reminder, and combinations thereof; wherein the note type is selected from the group consisting of Building Knowledge, Critical Knowledge, Action Items, ECO, Wish List, Space, Utilities, Asset and Building System;
wherein the menu for selecting for display a first set of information for one or more buildings further comprises an Equipment Super Search region comprising a means for selecting information pertaining to building equipment, wherein information pertaining to building equipment is selected from the group consisting of an equipment description, a major tag, a sub-location, a hyperlink to documents pertaining to equipment situated in the at least one building, and combinations thereof;
wherein the menu for selecting for display a first set of information for one or more buildings further comprises an Asset Super Search region comprising a means for selecting information pertaining to building assets;
wherein the menu for selecting for display a first set of information for one or more buildings further comprises a Utilities Super Search region comprising a means for selecting information pertaining to utilities;
wherein the menu for selecting for display a first set of information for one or more buildings further comprises an Access Super Search region comprising a means for selecting information pertaining to building access;
wherein the menu for selecting for display a first set of information for one or more buildings further comprises a National Fire Protection Association rating region comprising a means for selecting information pertaining to National Fire Protection Association ratings;
wherein the menu for selecting for display a first set of information for one or more buildings further comprises a precautionary statement region comprising a means for selecting information pertaining to precautionary statements.

Optionally, the embodiments of the invention further comprise a first menu means for designating a virtual building comprising a plurality of buildings.

Optionally, the first menu means for designating a virtual building is selected from the group consisting of hypertext, a computer icon, and a web button.

Optionally, the first menu further displays a first menu hyperlinking means for hyperlinking to a Report subregion, wherein the Report subregion displays a means for enabling a user to display a report of information stored in the electronic database on the at least one building.

Optionally, the first menu hyperlinking means for hyperlinking to a Report region is selected from the group consisting of hypertext, a computer icon, and a web button.

Optionally, the Report subregion further displaying a means for enabling a first user to display a report of information taken from a cached version of the electronic database that is stored in a non-volatile electronic memory in the first user's electronic computing device.

Optionally, the first menu further displays a first menu hyperlinking means for hyperlinking to an Administration subregion, wherein the Administration subregion displays information for the at least one building pertaining to personnel who are responsible for operating and managing the at least one building.

Optionally, the first menu hyperlinking means for hyperlinking to an Administration region is selected from the group consisting of hypertext, a computer icon, and a web button; wherein the second menu hyperlinking means for hyperlinking to a Building System subregion is selected from the group consisting of hypertext, a computer icon, and a web button; wherein the second menu hyperlinking means for hyperlinking to an Action Items subregion is selected from the group consisting of hypertext, a computer icon, and a web button; wherein the second menu hyperlinking means for hyperlinking to an ECO subregion is selected from the group consisting of hypertext, a computer icon, and a web button; wherein the second menu hyperlinking means for hyperlinking to an Equipment subregion is selected from the group consisting of hypertext, a computer icon, and a web button; wherein the second menu hyperlinking means for hyperlinking to a Building Personnel subregion is selected from the group consisting of hypertext, a computer icon, and a web button; wherein the second menu hyperlinking means for hyperlinking to a Maintenance Personnel subregion is selected from the group consisting of hypertext, a computer icon, and a web button; wherein the second menu hyperlinking means for hyperlinking to a Floor Plans subregion is selected from the group consisting of hypertext, a computer icon, and a web button; wherein the second menu hyperlinking means for hyperlinking to a Schedule subregion is selected from the group consisting of hypertext, a computer icon, and a web button; wherein the second menu hyperlinking means for hyperlinking to an Emergency subregion is selected from the group consisting of hypertext, a computer icon, and a web button; wherein the second menu hyperlinking means for hyperlinking to a Utilities subregion is selected from the group consisting of hypertext, a computer icon, and a web button.

Optionally, wherein the Building System subregion displays information pertaining to heating and cooling systems of the at least one building, wherein the information pertaining to heating and cooling systems is selected from the group consisting of an identifier for the information pertaining to the heating and cooling systems for the at least one building, an air handler unit type, an air handler unit configuration, an indication whether an air handler unit comprises a reheat design, an indication whether an air handler unit comprises a cooling design, an indication whether an air handler unit comprises a heating design, a control system type, an IP address for monitoring an air handler unit, a location of an air handler unit, an area served by an air handler unit, a note pertaining to an air handler unit, a hyperlink to documents relating to an handler unit, a precautionary statement, a National Fire Protection Association rating, and combinations thereof, wherein precautionary statements are selected from the group consisting of danger, warning, caution, note and none;
wherein the Utilities subregion displays information pertaining to utilities for the at least one building, wherein the information pertaining to the utilities for the at least one building is selected from the group consisting of a utility type, a shut-off type, a list of associated buildings, a note, a precautionary statement, a National Fire Protection Association rating, and combinations thereof, wherein precautionary statements are selected from the group consisting of danger, warning, caution, note and none;
wherein the Note subregion displays information pertaining to building operations and maintenance, wherein the information pertaining to building operations and maintenance is selected from the group consisting of a note type, a description, a priority, a responsible organization, a status, a status date, a completion date, a person assigned, a role, an assign date, a reminder, a precautionary statement, a National Fire Protection Association rating, and combinations thereof, wherein precautionary statements are selected from the group consisting of danger, warning, caution, note and none; wherein the note type is selected from the group consisting of Building Knowledge, Critical Knowledge, Action Items, ECO, Wish List, Space, Utilities, Asset and Building System;
wherein the Equipment subregion displays information pertaining to equipment situated in the at least one building, wherein the information pertaining to equipment situated in the at least one building is selected from the group consisting of an equipment description, a major tag, a sub-location, a hyperlink to documents pertaining to equipment situated in the at least one building, a precautionary statement, a National Fire Protection Association rating, and combinations thereof, wherein precautionary statements are selected from the group consisting of danger, warning, caution, note and none;
wherein the Asset subregion displays information pertaining to assets situated in the first building, wherein information pertaining to assets situated in the first building is selected from the group consisting of a short description, a category, a note, a precautionary statement, a National Fire Protection Association rating, and combinations thereof, wherein precautionary statements are selected from the group consisting of danger, warning, caution, note and none;
wherein the Action Items subregion displays information pertaining to outstanding maintenance issues for the at least one building, wherein the information pertaining to outstanding maintenance issues for the at least one building is selected from the group consisting of an action item identifier, a note type, a status, a start date, a finish date, a short description of an action item, a note, a category, a category detail, a timing, an occupancy, a responsible organization, a priority, a checklist to identify an ECO, a hyperlink to documents pertaining to an action item, a precautionary statement, a National Fire Protection Association rating, and combinations thereof, wherein precautionary statements are selected from the group consisting of danger, warning, caution, note and none;
wherein the ECO subregion displays information pertaining to Energy Conservation Opportunities for the at least one building, wherein the information pertaining to ECO for the at least one building is selected from the group consisting of an identifier for the information pertaining to the ECO for the at least one building, a note type, a status, a short description, a note, a category, a category detail, a timing, an occupancy, a responsible organization, a priority, a checkbox to indicate an ECO, a hyperlink to documents pertaining to Energy Conservation Opportunities in the at least one building, a precautionary statement, a National Fire Protection Association rating, and combinations thereof, wherein precautionary statements are selected from the group consisting of danger, warning, caution, note and none;
wherein the Building Personnel subregion displays information pertaining to administrative personnel associated with the at least one building, wherein the information pertaining to administrative personnel associated with the at least one building is selected from the group consisting of a first name, a last name, a telephone number, an email address, a position in an organization, a comment, a precautionary statement, a National Fire Protection Association rating, and combinations thereof, wherein precautionary statements are selected from the group consisting of danger, warning, caution, note and none;
wherein the Maintenance Personnel subregion displays information pertaining to maintenance personnel associated with the at least one building, wherein the information pertaining to maintenance personnel associated with the at least one building is selected from the group consisting of a first name, a last name, a telephone number, an email address, a position in an organization, a comment pertaining to a maintenance personnel for the at least one building, a precautionary statement, a National Fire Protection Association rating, and combinations thereof, wherein precautionary statements are selected from the group consisting of danger, warning, caution, note and none;
wherein the Floor Plans subregion displays information pertaining to floor plans and infrastructure plans for the at least one building, wherein the information pertaining to floor plans and infrastructure plans for the at least one building is selected from the group consisting of a floor, a plan type, a description pertaining to floor plans and infrastructure plans for the at least one building, a precautionary statement, a National Fire Protection Association rating, and combinations thereof, wherein precautionary statements are selected from the group consisting of danger, warning, caution, note and none;
wherein the Schedule subregion displays information pertaining to an occupancy schedule of the at least one building, wherein the information pertaining to the occupancy schedule of the at least one building is selected from the group consisting of a schedule, and a note pertaining to occupancy, a precautionary statement, a National Fire Protection Association rating, and combinations thereof, wherein precautionary statements are selected from the group consisting of danger, warning, caution, note and none;
wherein the Emergency subregion displays information pertaining to emergency procedures for the at least one building, wherein the information pertaining to the emergency procedures for the at least one building is selected from the group consisting of access, assets and threats, personnel, floor plans, a precautionary statement, a National Fire Protection Association rating, and combinations thereof, wherein precautionary statements are selected from the group consisting of danger, warning, caution, note and none.

Optionally: the Critical Knowledge subregion further displays a hyperlinking means for hyperlinking to the Input region, the Building Knowledge subregion further displays a hyperlinking means for hyperlinking to the Input region, the Building System subregion further displays a hyperlinking means for hyperlinking to the Input region, the Action Items subregion further displays a hyperlinking means for hyperlinking to the Input region, the Energy Conservation Opportunity (ECO) subregion further displays a hyperlinking means for hyperlinking to the Input region, the Equipment subregion further displays a hyperlinking means for hyperlinking to the Input region, the Building Personnel subregion further displays a hyperlinking means for hyperlinking to the Input region, the Maintenance Personnel subregion further displays a hyperlinking means for hyperlinking to the Input region, the Floor Plans subregion further displays a hyperlinking means for hyperlinking to the Input region, the Schedule subregion further displays a hyperlinking means for hyperlinking to the Input region, the Emergency subregion further displays a hyperlinking means for hyperlinking to the Input region, and the Utilities subregion further displays a hyperlinking means for hyperlinking to the Input region.

Optionally, the database comprises at least one database table, wherein different fields within the at least one database table are associable with different user access levels.

Some advantages of the embodiments of the apparatus were previously enumerated in the Summary section. Every advantageous feature does not need to be incorporated into every embodiment of the apparatus and/or methods.

Although these versions of the invention have been described in considerable detail, other versions are possible. For example, embodiments can comprise combinations of the features described herein, such as combinations of the dependent claims. Therefore, the spirit and scope of the appended claims should not be limited to the description of the versions contained therein.

I claim:

1. An electronic programmable apparatus to generate an electronic graphical user interface for permitting a user to interface with an electronic database configured to store information about a building or buildings, the apparatus comprising: an electronic computer processor, a volatile electronic computer memory and a non-volatile electronic computer memory in communication with the electronic computer processor, and an electronic display device for displaying the electronic graphical user interface wherein the electronic display device is in electronic communication with the electronic computer processor and the volatile and non-volatile electronic computer memories;
the electronic graphical user interface comprising:
a means for enabling a user to select at least one building from a plurality of buildings;
a first menu displaying: a first menu hyperlinking means for hyperlinking to a Buildings region, and a first menu hyperlinking means for hyperlinking to an Input region;
the Buildings region comprising a second menu displaying a second menu hyperlinking means for hyperlinking to a Critical Knowledge subregion, wherein the Critical Knowledge subregion displays information pertaining to critical operational metadata for the at least one building, the second menu further displaying a second menu hyperlinking means for hyperlinking to: a Building Knowledge subregion displaying building metadata and device metadata for the at least one building, a Building System subregion, an Action Items subregion, an Energy Conservation Opportunity (ECO) subregion, an Equipment subregion, a Building Personnel subregion, a Maintenance Personnel subregion, a Floor Plans subregion, a Schedule subregion, an Emergency subregion, a Note subregion, an Asset subregion, and a Utilities subregion;
the Input region displaying a plurality of controls for enabling a user to input data into the electronic database, the plurality of controls comprising: a means for enabling a user to specify a second building, a means for enabling a user to specify a second space located within the second building, a means for enabling a user to specify at least one subregion pertaining to the second space, a means for enabling a user to specify at least one attribute type of the at least one subregion pertaining to the second space.

2. The apparatus of claim 1, wherein the first menu hyperlinking means for hyperlinking to an Input region is selected from the group consisting of hypertext, a computer icon, and a web button.

3. The apparatus of claim 1, wherein the means for enabling a user to specify a second building is selected from the group consisting of a text entry box, a radio button, a computer icon, and a pull-down menu.

4. The apparatus of claim 1, wherein the means for enabling a user to specify a second space located within the second building is selected from the group consisting of a text entry box, a radio button, a computer icon, and a pull-down menu; wherein a specification of the second space is selected from the group consisting of a space name, a space type, metadata regarding the space, a precautionary statement, a National Fire Protection Association rating, a building floor, a compass direction, a room number, a key number, an indication for whether the space has a proxy access, an indication for whether the space has a key card access, an indication for whether the space is alarmed, an indication for whether the space is an emergency exit, an indication for whether the space is an elevator, an indication for whether the space is a stairwell an indication for whether the space is a building exit, an indication for whether the space is a main shut-off for a utility, and combinations thereof; wherein precautionary statements are selected from the group consisting of danger, warning, caution, note and none.

5. The apparatus of claim 1, wherein the means for enabling a user to specify at least one subregion pertaining to the second space comprises a plurality of buttons wherein each button corresponds to a subregion.

6. The apparatus of claim 1, wherein the means for enabling a user to specify at least one attribute type of the at least one subregion pertaining to the second space is selected from the group consisting of a hyperlinking means for hyperlinking to a Building System input subregion, a hyperlinking means for hyperlinking to a Utility input subregion, a hyperlinking means for hyperlinking to a Note input subregion, a hyperlinking means for hyperlinking to an Equipment input subregion, a hyperlinking means for hyperlinking to an Asset input subregion, and combinations thereof; wherein the hyperlinking means for hyperlinking to a Building System input subregion is selected from the group consisting of hypertext, a computer icon, and a web button; wherein the hyperlinking means for hyperlinking to a Utility input subregion is selected from the group consisting of hypertext, a computer icon, and a web button; wherein the hyperlinking means for hyperlinking to a Note input subregion is selected from the group consisting of hypertext, a computer icon, and a web button; wherein the hyperlinking means for hyperlinking to an Equipment input subregion is selected from the group consisting of hypertext, a computer icon, and a web button; wherein the hyperlinking means for hyperlinking to an Asset input subregion is selected from the group consisting of hypertext, a computer icon, and a web button.

7. The apparatus of claim 6, wherein the Building System input subregion displays a means for inputting information pertaining to heating and cooling systems of the at least one building, wherein the information pertaining to heating and cooling systems is selected from the group consisting of an identifier for the information pertaining to the heating and cooling systems for the at least one building, an air handler unit type, an air handler unit configuration, an indication whether an air handler unit comprises a reheat design, an indication whether an air handler unit comprises a cooling design, an indication whether an air handler unit comprises a heating design, a control system type, an IP address for monitoring an air handler unit, a location of an air handler unit, an area served by an air handler unit, a note pertaining to an air handler unit, a hyperlink to documents relating to an handler unit, a precautionary statement, a National Fire Protection Association rating, and combinations thereof, wherein precautionary statements are selected from the group consisting of danger, warning, caution, note and none;
wherein the Utilities input subregion displays a means for inputting information pertaining to utilities for the at least one building, wherein the information pertaining to the utilities for the at least one building is selected from the group consisting of a utility type, a shut-off type, a list of associated buildings, a note, a precautionary statement, a National Fire Protection Association rating, and combinations thereof, wherein precautionary statements are selected from the group consisting of danger, warning, caution, note and none;
wherein the Note input subregion displays a means for inputting information pertaining to building operations and maintenance, wherein the information pertaining to building operations and maintenance is selected from the group consisting of a note type, a description, a priority, a responsible organization, a status, a status date, a completion date, a person assigned, a role, an assign date, a reminder, a precautionary statement, a National Fire Protection Association rating, and combinations thereof, wherein precautionary statements are selected from the group consisting of danger, warning, caution, note and none; wherein the note type is selected from the group consisting of Building Knowledge, Critical Knowledge, Action Items, ECO, Wish List, Space, Utilities, Asset and Building System;
wherein the Equipment input subregion displays a means for inputting information pertaining to equipment situated in the at least one building, wherein the information pertaining to equipment situated in the at least one building is selected from the group consisting of an equipment description, a major tag, a sub-location, a hyperlink to documents pertaining to equipment situated in the at least one building, a precautionary statement, a National Fire Protection Association rating, and combinations thereof, wherein precautionary statements are selected from the group consisting of danger, warning, caution, note and none;
wherein the Asset input subregion displays a means for inputting information pertaining to assets situated in the first building, wherein information pertaining to assets situated in the first building is selected from the group consisting of a short description, a category, a note, a precautionary statement, a National Fire Protection Association rating, and combinations thereof, wherein precautionary statements are selected from the group consisting of danger, warning, caution, note and none.

8. The apparatus of claim 4, wherein the non-volatile memory contains code configured to cause: any precautionary statement designated at a level above note to be displayed at least in the Emergency subregion; any National Fire Protection Agency rating designated at a rating greater than zero to be displayed at least in the Emergency subregion and in the Critical Knowledge subregion; any information designated as a utility category type to be displayed at least in the Emergency subregion and the Utilities subregion; any information designated with a start date and an end date to be displayed at least in the Action Item subregion; any information designated as an ECO to be displayed at least in the ECO subregion; any information designated as a Building System to be displayed at least in the Building System subregion; any information designated as equipment to be displayed at least in the Equipment subregion; any information designated as building personnel to be displayed at least in the Building Personnel subregion; any information designated as maintenance personnel to be displayed at least in the Maintenance Personnel subregion; any information designated as floor plans to be displayed at least in the Floor Plans subregion; any information designated as a schedule to be displayed at least in the Schedule subregion; all information not displayed in the Critical Knowledge subregion or the Emergency subregion to be displayed at least in the Building Knowledge subregion; any note type that is designated as Building Knowledge to be displayed in the Building Knowledge subregion; any note type designated as Critical Knowledge to be displayed in the Critical knowledge subregion; any note type designated as an Action Item to be displayed in the Action Items subregion; and any note type designated as a Wish List to be displayed in the Wish List subregion.

9. The apparatus of claim 1, wherein the information pertaining to critical operational metadata for the at least one building is selected from the group consisting of an identifier for the critical operation metadata for the at least one building, a short description of a subject to which the critical operational metadata pertains, a note containing the critical operational metadata, a category to which the critical operational metadata pertains, a category detail, a checkbox to indicate an ECO, and a hyperlink to documents pertaining to the critical operational metadata for the at least one building, and combinations thereof.

10. The apparatus of claim 1, wherein the second menu hyperlinking means for hyperlinking to a Critical Knowledge subregion is selected from the group consisting of hypertext, a computer icon, and a web button.

11. The apparatus of claim 9, wherein the category to which the critical operational metadata pertains is selected from the group consisting of electrical, plumbing, fire, and controls.

12. The apparatus of claim 1, wherein the building and device metadata for the at least one building is selected from the group consisting of a description of the building metadata and device metadata for the at least one building, an identifier for the building metadata and device metadata for the at least one building, a device category, a category detail, a checkbox to indicate an ECO, a hyperlink to documents pertaining to the building metadata and device metadata for the at least one building, and combinations thereof.

13. The apparatus of claim 1, wherein the first menu hyperlinking means for hyperlinking to a Buildings region is selected from the group consisting of hypertext, a computer icon, and a web button.

14. The apparatus of claim 1, wherein the second menu hyperlinking means for hyperlinking to a Building Knowledge subregion is selected from the group consisting of hypertext, a computer icon, and a web button.

15. The apparatus of claim 1, wherein the means for enabling a user to select at least one building from a plurality of buildings is selected from the group consisting of a text entry box, a radio button, a computer icon, and a pull-down menu.

16. The apparatus of claim 1, wherein the first menu further displays a first menu hyperlinking means for hyperlinking to a Super Search region, wherein the Super Search region displays a menu for selecting for display a first set of information for one or more buildings.

17. The apparatus of claim 16, wherein the first set of information comprises locations indicated on a digital map.

18. The apparatus of claim 16, wherein the menu for selecting for display a first set of information for one or more buildings comprises a Building Super Search region, wherein the Building Super Search region comprises a means for selecting information pertaining to physical building characteristics; wherein the information pertaining to physical building characteristics is selected from the group consisting of a building, a building number, an area, an address, a city, a zip code, a square feet, a year built, a campus, a map grid, a schedule, a type, a tag number, a floor, a set of drawings, a drawing type, and combinations thereof;
wherein the menu for selecting for display a first set of information for one or more buildings further comprises a Control/System Super Search region; wherein the Control/System Super Search region comprises a means for selecting Building Controls, System Numbers, and Modes of Distribution, wherein Building Controls comprise control type and schedule and location, wherein System Numbers comprise numerical identifiers of system types and area covered, and wherein Modes of Distribution comprise air handler, mechanical, POT feeder, system type, and VFD;
wherein the menu for selecting for display a first set of information for one or more buildings further comprises a People Super Search region, wherein the People Super Search region comprises a means for selecting a name, an identification number, Contact Information, Building Positions, and Area Positions, wherein Contact Information comprises a contact type and a priority, wherein Building Positions comprises an inactive date and an active date range, wherein Area Positions comprises a position and an area assigned;
wherein the menu for selecting for display a first set of information for one or more buildings further comprises a Note Super Search region comprising a means for selecting information pertaining to building operations and maintenance, wherein the information pertaining to building operations and maintenance is selected from the group consisting of a note type, a description, a priority, a responsible organization, a status, a status date, a completion date, a person assigned, a role, an assign date, a reminder, and combinations thereof; wherein the note type is selected from the group consisting of Building Knowledge, Critical Knowledge, Action Items, ECO, Wish List, Space, Utilities, Asset and Building System;
wherein the menu for selecting for display a first set of information for one or more buildings further comprises an Equipment Super Search region comprising a means for selecting information pertaining to building equipment, wherein information pertaining to building equipment is selected from the group consisting of an equipment description, a major tag, a sub-location, a hyperlink to documents pertaining to equipment situated in the at least one building, and combinations thereof;
wherein the menu for selecting for display a first set of information for one or more buildings further comprises an Asset Super Search region comprising a means for selecting information pertaining to building assets;
wherein the menu for selecting for display a first set of information for one or more buildings further comprises a Utilities Super Search region comprising a means for selecting information pertaining to utilities;
wherein the menu for selecting for display a first set of information for one or more buildings further comprises an Access Super Search region comprising a means for selecting information pertaining to building access;
wherein the menu for selecting for display a first set of information for one or more buildings further comprises a National Fire Protection Association rating region comprising a means for selecting information pertaining to National Fire Protection Association ratings;
wherein the menu for selecting for display a first set of information for one or more buildings further comprises a precautionary statement region comprising a means for selecting information pertaining to precautionary statements.

19. The apparatus of claim 1, further comprising a first menu means for designating a virtual building comprising a plurality of buildings.

20. The apparatus of claim 19, wherein the first menu means for designating a virtual building is selected from the group consisting of hypertext, a computer icon, and a web button.

21. The apparatus of claim 1, wherein the first menu further displays a first menu hyperlinking means for hyperlinking to a Report subregion, wherein the Report subregion displays a means for enabling a user to display a report of information stored in the electronic database on the at least one building.

22. The apparatus of claim 21, wherein the first menu hyperlinking means for hyperlinking to a Report region is selected from the group consisting of hypertext, a computer icon, and a web button.

23. The apparatus of claim 21, the Report subregion further displaying a means for enabling a first user to display a report of information taken from a cached version of the electronic database that is stored in a non-volatile electronic memory in the first user's electronic computing device.

24. The apparatus of claim 1, wherein the first menu further displays a first menu hyperlinking means for hyperlinking to an Administration subregion, wherein the Administration subregion displays information for the at least one building pertaining to personnel who are responsible for operating and managing the at least one building.

25. The apparatus of claim 24, wherein the first menu hyperlinking means for hyperlinking to an Administration region is selected from the group consisting of hypertext, a computer icon, and a web button;
wherein the second menu hyperlinking means for hyperlinking to a Building System subregion is selected from the group consisting of hypertext, a computer icon, and a web button;
wherein the second menu hyperlinking means for hyperlinking to an Action Items subregion is selected from the group consisting of hypertext, a computer icon, and a web button;
wherein the second menu hyperlinking means for hyperlinking to an ECO subregion is selected from the group consisting of hypertext, a computer icon, and a web button;
wherein the second menu hyperlinking means for hyperlinking to an Equipment subregion is selected from the group consisting of hypertext, a computer icon, and a web button;
wherein the second menu hyperlinking means for hyperlinking to a Building Personnel subregion is selected from the group consisting of hypertext, a computer icon, and a web button;
wherein the second menu hyperlinking means for hyperlinking to a Maintenance Personnel subregion is selected from the group consisting of hypertext, a computer icon, and a web button;
wherein the second menu hyperlinking means for hyperlinking to a Floor Plans subregion is selected from the group consisting of hypertext, a computer icon, and a web button;
wherein the second menu hyperlinking means for hyperlinking to a Schedule subregion is selected from the group consisting of hypertext, a computer icon, and a web button;
wherein the second menu hyperlinking means for hyperlinking to an Emergency subregion is selected from the group consisting of hypertext, a computer icon, and a web button;
wherein the second menu hyperlinking means for hyperlinking to a Utilities subregion is selected from the group consisting of hypertext, a computer icon, and a web button;
wherein the second menu hyperlinking means for hyperlinking to a Note subregion is selected from the group consisting of hypertext, a computer icon, and a web button;
wherein the second menu hyperlinking means for hyperlinking to an Asset subregion is selected from the group consisting of hypertext, a computer icon, and a web button.

26. The apparatus of claim 25, wherein the Building System subregion displays information pertaining to heating and cooling systems of the at least one building, wherein the information pertaining to heating and cooling systems is selected from the group consisting of an identifier for the information pertaining to the heating and cooling systems for the at least one building, an air handler unit type, an air handler unit configuration, an indication whether an air handler unit comprises a reheat design, an indication whether an air handler unit comprises a cooling design, an indication whether an air handler unit comprises a heating design, a control system type, an IP address for monitoring an air handler unit, a location of an air handler unit, an area served by an air handler unit, a note pertaining to an air handler unit, a hyperlink to documents relating to an handler unit, a precautionary statement, a National Fire Protection Association rating, and combinations thereof, wherein precautionary statements are selected from the group consisting of danger, warning, caution, note and none;
wherein the Utilities subregion displays information pertaining to utilities for the at least one building, wherein the information pertaining to the utilities for the at least one building is selected from the group consisting of a utility type, a shut-off type, a list of associated buildings, a note, a precautionary statement, a National Fire Protection Association rating, and combinations thereof, wherein precautionary statements are selected from the group consisting of danger, warning, caution, note and none;
wherein the Note subregion displays information pertaining to building operations and maintenance, wherein the information pertaining to building operations and maintenance is selected from the group consisting of a note type, a description, a priority, a responsible organization, a status, a status date, a completion date, a person assigned, a role, an assign date, a reminder, a precautionary statement, a National Fire Protection Association rating, and combinations thereof, wherein precautionary statements are selected from the group consisting of danger, warning, caution, note and none; wherein the note type is selected from the group consisting of Building Knowledge, Critical Knowledge, Action Items, ECO, Wish List, Space, Utilities, Asset and Building System;
wherein the Equipment subregion displays information pertaining to equipment situated in the at least one building, wherein the information pertaining to equipment situated in the at least one building is selected from the group consisting of an equipment description, a major tag, a sub-location, a hyperlink to documents pertaining to equipment situated in the at least one building, a precautionary statement, a National Fire Protection Association rating, and combinations thereof, wherein precautionary statements are selected from the group consisting of danger, warning, caution, note and none;
wherein the Asset subregion displays information pertaining to assets situated in the first building, wherein information pertaining to assets situated in the first building is selected from the group consisting of a short description, a category, a note, a precautionary statement, a National Fire Protection Association rating, and combinations thereof, wherein precautionary statements are selected from the group consisting of danger, warning, caution, note and none;
wherein the Action Items subregion displays information pertaining to outstanding maintenance issues for the at least one building, wherein the information pertaining to outstanding maintenance issues for the at least one building is selected from the group consisting of an action item identifier, a note type, a status, a start date, a finish date, a short description of an action item, a note, a category, a category detail, a timing, an occupancy, a responsible organization, a priority, a checklist to identify an ECO, a hyperlink to documents pertaining to an action item, a precautionary statement, a National Fire Protection Association rating, and combinations thereof, wherein precautionary statements are selected from the group consisting of danger, warning, caution, note and none;
wherein the ECO subregion displays information pertaining to Energy Conservation Opportunities for the at least one building, wherein the information pertaining to ECO for the at least one building is selected from the group consisting of an identifier for the information pertaining to the ECO for the at least one building, a note type, a status, a short description, a note, a category, a category detail, a timing, an occupancy, a responsible organization, a priority, a checkbox to indicate an ECO, a hyperlink to documents pertaining to Energy Conservation Opportunities in the at least one building, a precautionary statement, a National Fire Protection Association rating, and combinations thereof, wherein precautionary statements are selected from the group consisting of danger, warning, caution, note and none;
wherein the Building Personnel subregion displays information pertaining to administrative personnel associated with the at least one building, wherein the information pertaining to administrative personnel associated with the at least one building is selected from the group consisting of a first name, a last name, a telephone number, an email address, a position in an organization, a comment, a precautionary statement, a National Fire Protection Association rating, and combinations thereof, wherein precautionary statements are selected from the group consisting of danger, warning, caution, note and none;
wherein the Maintenance Personnel subregion displays information pertaining to maintenance personnel associated with the at least one building, wherein the information pertaining to maintenance personnel associated with the at least one building is selected from the group consisting of a first name, a last name, a telephone number, an email address, a position in an organization, a comment pertaining to a maintenance personnel for the at least one building, a precautionary statement, a National Fire Protection Association rating, and combinations thereof, wherein precautionary statements are selected from the group consisting of danger, warning, caution, note and none;
wherein the Floor Plans subregion displays information pertaining to floor plans and infrastructure plans for the at least one building, wherein the information pertaining to floor plans and infrastructure plans for the at least one building is selected from the group consisting of a floor, a plan type, a description pertaining to floor plans and infrastructure plans for the at least one building, a precautionary statement, a National Fire Protection Association rating, and combinations thereof, wherein precautionary statements are selected from the group consisting of danger, warning, caution, note and none;
wherein the Schedule subregion displays information pertaining to an occupancy schedule of the at least one building, wherein the information pertaining to the occupancy schedule of the at least one building is selected from the group consisting of a schedule, and a note pertaining to occupancy, a precautionary statement, a National Fire Protection Association rating, and combinations thereof, wherein precautionary statements are selected from the group consisting of danger, warning, caution, note and none;
wherein the Emergency subregion displays information pertaining to emergency procedures for the at least one building, wherein the information pertaining to the emergency procedures for the at least one building is selected from the group consisting of access, assets and threats, personnel, floor plans, a precautionary statement, a National Fire Protection Association rating, and combinations thereof, wherein precautionary statements are selected from the group consisting of danger, warning, caution, note and none.

27. The apparatus of claim 1, wherein: the Critical Knowledge subregion further displays a hyperlinking means for hyperlinking to the Input region, the Building Knowledge subregion further displays a hyperlinking means for hyperlinking to the Input region, the Building System subregion further displays a hyperlinking means for hyperlinking to the Input region, the Action Items subregion further displays a hyperlinking means for hyperlinking to the Input region, the Energy Conservation Opportunity (ECO) subregion further displays a hyperlinking means for hyperlinking to the Input region, the Equipment subregion further displays a hyperlinking means for hyperlinking to the Input region, the Building Personnel subregion further displays a hyperlinking means for hyperlinking to the Input region, the Maintenance Personnel subregion further displays a hyperlinking means for hyperlinking to the Input region, the Floor Plans subregion further displays a hyperlinking means for hyperlinking to the Input region, the Schedule subregion further displays a hyperlinking means for hyperlinking to the Input region, the Emergency subregion further displays a hyperlinking means for hyperlinking to the Input region, and the Utilities subregion further displays a hyperlinking means for hyperlinking to the Input region.

28. The apparatus of claim 1, the database comprising at least one database table, wherein different fields within the at least one database table are associable with different user access levels.

29. A method for generating and display an electronic graphical user interface for permitting a user to interface with an electronic database configured to store information about a building or buildings, the method utilizing an electronic computer processor, a volatile electronic computer memory and a non-volatile electronic computer memory in communication with the electronic computer processor, and an electronic display device for displaying the electronic graphical user interface wherein the electronic display device is in electronic communication with the electronic computer processor and the volatile and non-volatile electronic computer memories, the method comprising:
a. generating a means for enabling a user to select at least one building from a plurality of buildings, the means for enabling a user to select at least one building from a plurality of buildings comprising a portion of the electronic graphical user interface;
b. displaying, in the electronic display device, the means for enabling a user to select at least one building from a plurality of buildings;
c. generating a first menu displaying: a first menu hyperlinking means for hyperlinking to a Buildings region, and a first menu hyperlinking means for hyperlinking to an Input region; wherein the first menu comprises a portion of the electronic graphical user interface;
d. displaying, in the electronic display device, the first menu;
e. generating within the Buildings region a second menu displaying a second menu hyperlinking means for hyperlinking to a Critical Knowledge subregion, wherein the second menu comprises a portion of the electronic graphical user interface;
f. displaying, in the electronic display device, the second menu;
g. generating the Critical Knowledge subregion comprising a portion of the electronic graphical user interface, wherein the Critical Knowledge subregion displays information pertaining to critical operational metadata for the at least one building, wherein the Critical Knowledge subregion further displays a hyperlinking means for hyperlinking to the Input region, the second menu further displaying a second menu hyperlinking means for hyperlinking to: a Building Knowledge subregion displaying building metadata and device metadata for the at least one building, a Building System subregion, an Action Items subregion, an Energy Conservation Opportunity (ECO) subregion, an Equipment subregion, a Building Personnel subregion, a Maintenance Personnel subregion, a Floor Plans subregion, a Schedule subregion, an Emergency subregion, a Note subregion, an Asset subregion, and a Utilities subregion;
h. displaying, in the electronic display device, the Critical Knowledge subregion;
i. generating the Input region comprising a portion of the electronic graphical user interface, the Input region comprising a plurality of controls for enabling a user to input data into the electronic database, the plurality of controls comprising: a means for enabling a user to specify a second building, a means for enabling a user to specify a second space located within the second building, a means for enabling a user to specify at least one subregion pertaining to the second space, a means for enabling a user to specify at least one attribute type of the at least one subregion pertaining to the second space;
j. displaying, in the electronic display device, the input region.

30. The method of claim 29, wherein the means for enabling a user to specify a second space located within the second building is selected from the group consisting of a text entry box, a radio button, a computer icon, and a pull-down menu; wherein a specification of the second space is selected from the group consisting of a space name, a space type, metadata regarding the space, a precautionary statement, a National Fire Protection Association rating, a building floor, a compass direction, a room number, a key number, an indication for whether the space has a proxy access, an indication for whether the space has a key card access, an indication for whether the space is alarmed, an indication for whether the space is an emergency exit, an indication for whether the space is an elevator, an indication for whether the space is a stairwell an indication for whether the space is a building exit, an indication for whether the space is a main shut-off for a utility, and combinations thereof; wherein precautionary statements are selected from the group consisting of danger, warning, caution, note and none.

31. The method of claim 30, wherein the non-volatile memory contains code configured to cause: any precautionary statement designated at a level above note to be displayed at least in the Emergency subregion; any National Fire Protection Agency rating designated at a rating greater than zero to be displayed at least in the Emergency subregion and in the Critical Knowledge subregion; any information designated as a utility category type to be displayed at least in the Emergency subregion and the Utilities subregion; any information designated with a start date and an end date to be displayed at least in the Action Item subregion; any information designated as an ECO to be displayed at least in the ECO subregion; any information designated as a Building System to be displayed at least in the Building System subregion; any information designated as equipment to be displayed at least in the Equipment subregion; any information designated as building personnel to be displayed at least in the Building Personnel subregion; any information designated as maintenance personnel to be displayed at least in the Maintenance Personnel subregion; any information designated as floor plans to be displayed at least in the Floor Plans subregion; any information designated as a schedule to be displayed at least in the Schedule subregion; all information not displayed in the Critical Knowledge subregion or the Emergency subregion to be displayed at least in the Building Knowledge subregion; any note type that is designated as Building Knowledge to be displayed in the Building Knowledge subregion; any note type designated as Critical Knowledge to be displayed in the Critical knowledge subregion; any note type designated as an Action Item to be displayed in the Action Items subregion; and any note type designated as a Wish List to be displayed in the Wish List subregion.
